(19) United States
(12) Patent Application Publication
(10) Pub. No.: US 2026/0229174 A1
(43) Pub. Date: Aug. 6, 2026

(54) DISPLAY DEVICE AND METHOD FOR DRIVING SAME

(71) Applicant: Sharp Display Technology Corporation, Kameyama City, Mie (JP)

(72) Inventor: Kohhei TANAKA, Kameyama City (JP)

(21) Appl. No.: 19/146,323

(22) PCT Filed: Feb. 8, 2023
(86) PCT No.: PCT/JP2023/004108

§ 371 Date: Jul. 8, 2025

(51) Int. Cl. G09G 3/3233

(52) U.S. Cl. CPC G09G 3/3233; G09G 2300/043; G09G 2300/0819; G09G 2310/08; G09G 2320/0247; G09G 2330/021

(57) ABSTRACT

In a current-driven display device of an internal compensation type, an on-bias application period Tobs is provided in order to apply an on-bias voltage to the drive transistor in the pixel circuit within non-light emission periods in both refresh frame periods and non-refresh frame periods in a pause driving mode. During the non-light emission period in a refresh frame period, the pixel circuit is driven via existing signal lines and voltage lines such that the on-bias voltage is applied during the period between the start of the non-light emission period and the start of writing of a data voltage to the pixel circuit. This reduces the difference in the stress state of the drive transistor between refresh frame periods and non-refresh frame periods.

### TECHNICAL FIELD

The following disclosure relates to a display device, and more particularly to a current drive type display device including a display element driven by a current such as an organic electroluminescence (EL) element, and a method for driving the same.

### BACKGROUND ART

In recent years, organic EL display devices using organic EL elements (also called organic light emitting diodes (OLEDs)) have been put to practical use. An organic EL element is a self-luminous display element that emits light with a luminance that corresponds to the current flowing therethrough. A pixel circuit of an organic EL display device includes, in addition to an organic EL element, a drive transistor that controls the current flowing through the organic EL element, and the like. Since variations and shifts occur in the characteristics of the drive transistors, it is necessary to compensate for these variations and shifts in characteristics in order to achieve high-quality display in an organic EL display device. Therefore, some pixel circuits of organic EL display devices are configured to compensate for variations and shifts in the threshold voltage of the drive transistor within the pixel circuit (hereinafter, compensation for such variations and shifts in threshold voltage is referred to as “threshold compensation”, and the method of performing threshold compensation within the pixel circuit in this manner is referred to as the “internal compensation method”).

Also, display devices configured to be driven at a low frequency in order to reduce power consumption are known. In such a display device, for example when displaying a still image, power consumption can be significantly reduced by performing low-frequency driving in which the refresh rate is significantly reduced by inserting a frame period in which no refresh operation is performed between adjacent frame periods in which a refresh operation is performed.

When low-frequency driving is performed in an organic EL display device, the organic EL element in each pixel circuit is turned off by the emission control transistor during a non-light emission period provided for each refresh frame period, which is a frame period in which a refresh operation is performed. However, during a non-refresh frame period, which is a frame period in which no refresh operation is performed, the operation of the drive circuit stops and the pixel circuit continues to emit light at a luminance that corresponds to a data voltage written to the pixel circuit in the previous refresh frame period. Generally, when displaying a still image, a period during which display is continued without performing the refresh operation (which is made up of a plurality of consecutive non-refresh frame periods, and hereinafter referred to as a “pause period”) is much longer than a period during which the refresh operation is performed (which is made up of one refresh frame period or a plurality of consecutive refresh frame periods, and hereinafter referred to as a “drive period”), and such a drive period and a pause period alternately appear during the display operation. Therefore, when a still image is displayed by low-frequency driving, turning off of the organic EL element in the drive period is visually recognized as flicker.

On the other hands, Patent Document 1 describes a pixel circuit and a driving method thereof that are configured such that in addition to reducing luminance by turning off the organic EL element (light-emitting diode 304) during the drive period (data refresh period T_refrech), luminance reduction also occurs at an appropriate frequency during the pause period (extended blanking period T_blank), in order to eliminate flicker that is visible when low-frequency driving is performed.

### CITATION LIST

### Patent Documents

[Patent Document 1] US 2019/0057646 A
[Patent Document 2] JP 2020-112795 A

### SUMMARY

### Technical Problem

However, even if an organic EL display device is configured to reduce a luminance at an appropriate frequency in the pause period in the low-frequency driving (hereinafter, such a configuration will be referred to as a “periodic extinguishing configuration”), flicker is still visible during low-frequency driving because the thin-film transistor functioning as the drive transistor in the pixel circuits has hysteresis characteristic.

In this regard, Patent Document 1 describes a method of intentionally applying a bias stress voltage (hereinafter referred to as an “on-bias voltage” or simply “bias voltage”) to a drive transistor not only in a drive period (data refresh period T_refrech) but also in a pause period (extended blanking period T_blank) to balance the effects of the hysteresis characteristics (on the luminance of the organic EL element). Furthermore, Patent Document 2 also describes a configuration in which an on-bias voltage is applied to a drive transistor in order to reduce the hysteresis characteristic of the drive transistor in low-frequency driving of an organic light-emitting diode display.

However, in the display devices described in Patent Documents 1 and 2, the application of an on-bias voltage to the drive transistors leads to a complex configuration and drive of the pixel circuit. This prevents a high-definition display and increases the circuit scale.

Therefore, in current-driven display devices such as organic EL display devices that perform low-frequency driving, it is desirable to sufficiently suppress the occurrence of flicker by applying an on-bias voltage to the drive transistor while preventing the complexity of the pixel circuit configuration and driving.

### Solution to the Problems

A display device according to some embodiments of the disclosure includes:
a display portion including a plurality of pixel circuits;
a drive circuit configured to drive the plurality of pixel circuits; and
a display control circuit configured to control the drive circuit such that a drive period and a pause period alternately appear, the drive period consisting of one or more refresh frame periods in which voltage of a plurality of data signals is written, as data voltage, to the plurality of pixel circuits, the pause period consisting of one or more non-refresh frame periods in which writing of data voltage to the plurality of pixel circuits is stopped.

In the display device, each of the plurality of pixel circuits includes
a display element configured to be driven by a current,
a drive transistor arranged in series with the display element and including a control terminal, a first conduction terminal, and a second conduction terminal,
a holding capacitor having one terminal connected to the control terminal of the drive transistor and thus being configured to hold a voltage of the control terminal of the drive transistor,
a write control transistor, as a switching element, having a first conduction terminal configured to receive a data voltage to be written to the holding capacitor and a second conduction terminal connected to the first conduction terminal of the drive transistor,
a threshold compensation transistor, as a switching element, arranged between the second conduction terminal and the control terminal of the drive transistor, and configured to put the drive transistor in a diode-connected state when in ON state,
at least one emission control transistor, as a switching element, arranged in series with the display element and the drive transistor, and
a bias application circuit configured to apply, to the first conduction terminal of the drive transistor, a bias voltage for reducing threshold voltage shift caused by a hysteresis characteristic of the drive transistor.

In each of the plurality of pixel circuits, the bias application circuit has
a first terminal configured to receive one of signals provided to control terminals of transistors each of which is included in the each of the plurality of pixel circuits or in another pixel circuit, but none of which are included in the bias application circuit, or to receive one of the power supply voltages of the plurality of pixel circuits, and
a second terminal connected to the first conductive terminal of the drive transistor, and
the bias application circuit is configured to apply the bias voltage to the first conductive terminal of the drive transistor based on the signal or the voltage received at the first terminal.

A driving method according to some other embodiments of the disclosure is a method for driving a display device using a display element driven by a current, the display device including a display portion including a plurality of pixel circuits,
each of the plurality of pixel circuits including:
   a display element driven by a current;
   a drive transistor having a control terminal, a first conduction terminal, and a second conduction terminal, and arranged in series with the display element;
   a holding capacitor having one terminal connected to the control terminal of the drive transistor and thus being configured to hold a voltage at the control terminal of the drive transistor;
   a write control transistor, as a switching element, having a first conduction terminal configured to receive a data voltage to be written to the holding capacitor and a second conduction terminal connected to the first conduction terminal of the drive transistor;
   a threshold compensation transistor, as a switching element, arranged between the second conduction terminal and the control terminal of the drive transistor, and configured to put the drive transistor in a diode-connected state when in ON state;
   at least one emission control transistor, as a switching element, arranged in series with the display element and the drive transistor, and
   a bias application circuit configured to apply, to the first conductive terminal of the drive transistor, a bias voltage for reducing threshold voltage shift caused by a hysteresis characteristic of the drive transistor, the bias application circuit having a first terminal configured to receive one of signals provided to control terminals of transistors each of which s included in the each of the plurality of pixel circuits or in another pixel circuit, but none of which are included in the bias application circuit, or to receive one of the power supply voltages of the plurality of pixel circuits, and having a second terminal connected to the first conductive terminal of the drive transistor,
the method including a pause driving step of driving the plurality of pixel circuits such that a drive period and a pause period alternately appear, the drive period consisting of one or more refresh frame periods in which voltage of a plurality of data signals is written to the plurality of pixel circuits as data voltage, the pause period consisting of one or more non-refresh frame periods in which writing of data voltage to the plurality of pixel circuits is stopped,
the pause driving step including a bias application step of driving the plurality of pixel circuits such that the bias application circuit applies the bias voltage to the first conduction terminal of the drive transistor based on the signal or the voltage received at the first terminal within a period during which the emission control transistor in each of the plurality of pixel circuits is in OFF state in both the refresh frame period and the non-refresh frame period.

### Effects of the Disclosure

According to some of the above-described embodiments of the disclosure, in an internal compensation type display device having a pixel circuit including a current-driven display element, a drive transistor, a write control transistor, a threshold compensation transistor, an emission control transistor, and a holding capacitor, each pixel circuit further includes a bias application circuit configured to apply, to a first conduction terminal of the drive transistor, a bias voltage for reducing threshold voltage shift caused by a hysteresis characteristic of the drive transistor. In each of the plurality of pixel circuits in the display portion, the bias application circuit has a first terminal configured to receive one of signals provided to control terminals of transistors included in the each pixel circuit or in another pixel circuit, but not included in the bias application circuit, or to receive one of the power supply voltages of the plurality of pixel circuits, and has a second terminal connected to a first conductive terminal of the drive transistor. In such a display device, when pause driving is performed in which a drive period consisting of a refresh frame period and a pause period consisting of a non-refresh frame period alternate, the bias voltage is applied to the first conductive terminal of the drive transistor based on the signal or voltage received by the bias application circuit at its first terminal. This reduces the difference in the stress state of the drive transistor between refresh frame periods and non-refresh frame periods, even when pause driving is performed, and makes it possible to suppress flicker without complicating the pixel circuit configuration or driving.

### BRIEF DESCRIPTION OF THE DRAWINGS

FIG. 1 is a block diagram illustrating an overall configuration of a display device according to a first embodiment.

FIG. 2 is a timing chart for describing a schematic operation in a normal driving mode of the display device according to the first embodiment.

FIG. 3 is a timing chart for describing a schematic operation in a pause driving mode of the display device according to the first embodiment.

FIG. 4 is a circuit diagram illustrating a configuration of a pixel circuit in the first embodiment.

FIG. 5 is a timing chart for describing an operation of the pixel circuit in the pause driving mode in the first embodiment.

FIG. 6 is a timing chart for describing an effect of the first embodiment.

FIG. 7 is a circuit diagram illustrating a configuration of a pixel circuit in a display device according to a second embodiment.

FIG. 8 is a timing chart for describing an operation of the pixel circuit in the pause driving mode in the second embodiment.

FIG. 9 is a circuit diagram illustrating a first configuration example of the pixel circuit in the display device according to a third embodiment.

FIG. 10 is a timing chart for describing an operation of a pixel circuit in the pause driving mode in the third embodiment.

FIG. 11 is a circuit diagram illustrating a second configuration example of the pixel circuit in the display device according to the third embodiment.

FIG. 12 consists of circuit diagrams (A-D) for describing several configuration examples of a pixel circuit according to a fourth embodiment.

FIG. 13 is a circuit diagram illustrating a configuration of a pixel circuit in a display device according to a fifth embodiment.

FIG. 14 is a timing chart for describing an operation of the pixel circuit in the pause driving mode in the fifth embodiment.

### DESCRIPTION OF EMBODIMENTS

Hereinafter, embodiments will be described with reference to the accompanying drawings. In each transistor mentioned below, a gate terminal corresponds to a control terminal, one of a drain terminal and a source terminal corresponds to a first conduction terminal, and the other corresponds to a second conduction terminal. In addition, the transistors in the following embodiments are, for example, thin film transistors, but the disclosure is not limited to this. Furthermore, “connection” in the present specification means “electrical connection” unless otherwise specified, and includes not only a case of meaning direct connection but also a case of meaning indirect connection via another element within the scope not departing from the gist of the disclosure.

### 1. First Embodiment

### 1.1 Overall Configuration

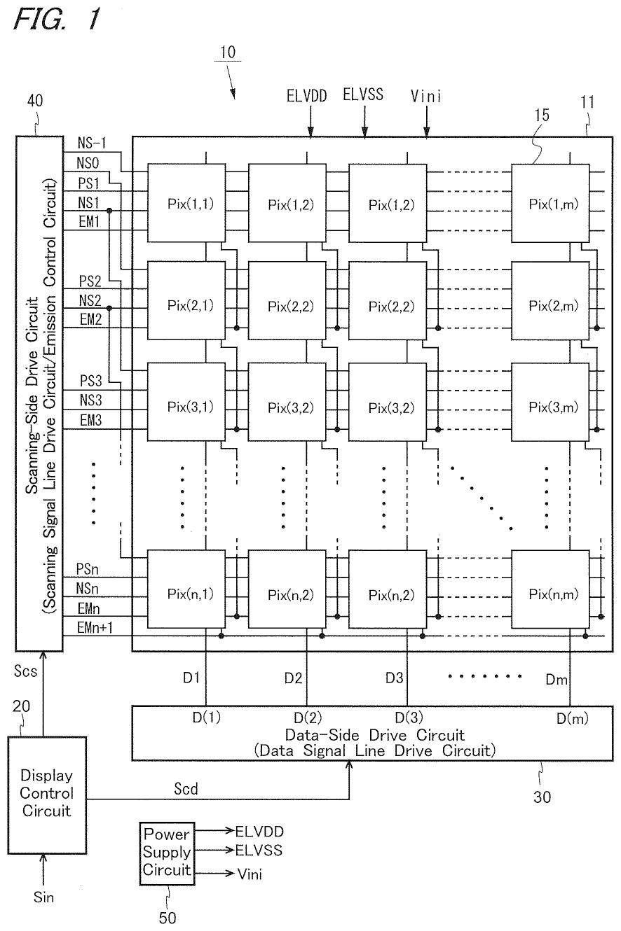

FIG. 1 is a block diagram illustrating an overall configuration of a display device 10 according to a first embodiment. The display device 10 is an organic EL display device that performs internal compensation, and each pixel circuit in the display device 10 has a function of compensating for variations and shifts in the threshold voltage of the drive transistor therein. The display device 10 also has two operation modes: a normal driving mode and a pause driving mode. That is, the display device 10 operates such that, in the normal driving mode, a refresh frame period Trf for rewriting image data (data voltage in each pixel circuit) of a display portion continues, and in the pause driving mode, a drive period TD consisting of only the refresh frame period Trf and a pause period TP consisting of a plurality of non-refresh frame periods Tnrf for stopping rewriting of image data of the display portion alternately appear.

As illustrated in FIG. 1, the display device 10 includes a display portion 11, a display control circuit 20, a data-side drive circuit 30, a scanning-side drive circuit 40, and a power supply circuit 50. The data-side drive circuit 30 functions as a data signal line drive circuit. The scanning-side drive circuit 40 functions as a scanning signal line drive circuit and an emission control circuit. In the configuration illustrated in FIG. 1, these two circuits are configured as one scanning-side drive circuit 40, but these two circuits may be appropriately separated, or these two circuits may be arranged separately on one side and the other side of the display portion 11. At least a part of the data-side drive circuit and the scanning-side drive circuit may be formed integrally with the display portion 11. These same applies to other embodiments and modified examples described below. The power supply circuit 50 generates a high-level power supply voltage ELVDD, a low-level power supply voltage ELVSS, and an initialization voltage Vini, which are described below, to be supplied to the display portion 11, as well as power supply voltages (not shown) to be supplied to the display control circuit 20, the data-side drive circuit 30, and the scanning-side drive circuit 40.

The display portion 11 is provided with m (m is an integer of 2 or more) data signal lines D1, D2, . . . , Dm, n first scanning signal lines PS1, PS2, . . . , PSn intersecting the data signal lines, and n+2 (n is an integer of 2 or more) second scanning signal lines NS−1, NS0, NS1, . . . , NSn. In addition, the display portion 11 is provided with n+1 emission control lines EM1 to EMn+1 intersecting with the data signal lines D1, D2, . . . , Dm, and of these, the n emission control lines EM1 to EMn are arranged along the n first scanning signal lines PS1, PS2, . . . , PSn, respectively. The display portion 11 is also provided with m×n pixel circuits 15 arranged in a matrix along the m data signal lines D1 to Dm and the n first scanning signal lines PS1 to PSn. Each pixel circuit 15 corresponds to one of the m data signal lines D1 to Dm and one of the n first scanning signal lines PS1 to PSn (hereinafter, when distinguishing each pixel circuit 15 from another, a pixel circuit corresponding to the i-th first scanning signal line PSi and the j-th data signal line Dj is also referred to as the “pixel circuit in the i-th row and j-th column” and is indicated by the symbol “Pix(i, j)”). Each pixel circuit 15 corresponds to one of the n second scanning signal lines NS1 to NSn, and also corresponds to one of the n emission control lines EM1 to EMn. The data-side drive circuit 30 that drives the data signal lines D1, D2, . . . , Dm, and the scanning-side drive circuit 40 that drives the first scanning signal lines PS1, PS2, . . . , PSn, the second scanning signal lines NS−1, NS0, NS1, . . . , NSn, and the emission control lines EM1 to EMn constitute a drive circuit that drives m×n pixel circuits 15 in the display portion 11.

In addition, the display portion 11 is provided with a power supply line (not shown) common to each pixel circuit 15. That is, a first power supply line (hereinafter referred to as a “high-level power supply line” and indicated by the symbol “ELVDD” like the high-level power supply voltage) for supplying the high-level power supply voltage ELVDD required to drive an organic EL element described below, and a second power supply line (hereinafter referred to as a “low-level power supply line” and indicated by the symbol “ELVSS” like the low-level power supply voltage) for supplying the low-level power supply voltage ELVSS required to drive the organic EL element are provided. Furthermore, the display portion 11 is also provided with an initialization voltage line (indicated by the symbol “Vini” like the initialization voltage) not illustrated in the figure for supplying an initialization voltage Vini used in a reset operation (also referred to as an “initialization operation”) for initializing each pixel circuit 15. The high-level power supply voltage ELVDD, the low-level power supply voltage ELVSS, and the initialization voltage Vini are supplied from a power supply circuit 50.

The display control circuit 20 receives an input signal Sin from outside of the display device 10, which includes image information representing the image to be displayed and timing control information for image display, generates a data-side control signal Scd and a scanning-side control signal Scs based on the input signal Sin, and outputs the data-side control signal Scd to the data-side drive circuit 30 and the scanning-side control signal Scs to the scanning-side drive circuit 40.

The data-side drive circuit 30 drives the data signal lines D1 to Dm based on the data-side control signal Scd from the display control circuit 20. Specifically, in the refresh frame period Trf, the data-side drive circuit 30 generates m data signals D(1) to D(m) representing an image to be displayed based on the data-side control signal Scd and applies the data signals D(1) to D(m) to the data signal lines D1 to Dm, respectively.

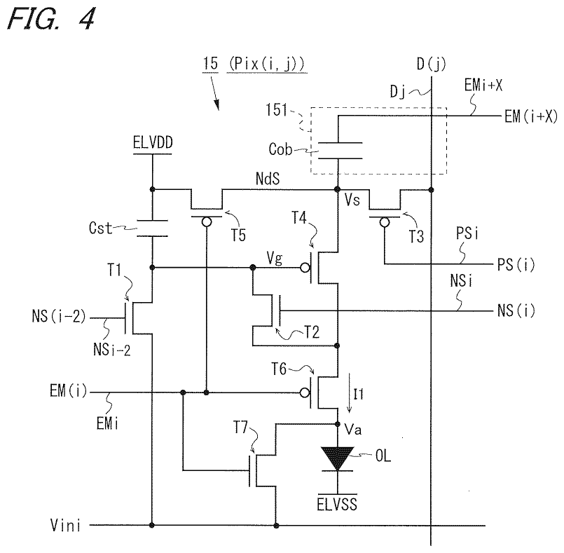

The scanning-side drive circuit 40 functions as a scanning signal line drive circuit that drives n first scanning signal lines PS1 to PSn and n+2 second scanning signal lines NS−1 to NSn based on a scanning-side control signal Scs from the display control circuit 20, and as an emission control circuit that drives n+1 emission control lines EM1 to EMn+1. Specifically, in the refresh frame period Trf, the scanning-side drive circuit 40, as a scanning signal line drive circuit, sequentially selects n first scanning signal lines PS1 to PSn each for a predetermined period corresponding to one horizontal period, and sequentially selects n+2 second scanning signal lines NS−1 to NSn each for a predetermined period corresponding to one horizontal period, based on the scanning-side control signal Scs. Furthermore, in the refresh frame period Trf, the scanning-side drive circuit 40 drives the emission control lines EM1 to EMn+1 such that the emission control lines EM1 to EMn are selectively inactivated in conjunction with the above-mentioned driving of the first and second scanning signal lines PS1 to PSn, NS−1 to NSn. The period during which the i-th emission control line EMi is in an activated state is a light emission period of the i-th row of pixel circuits Pix(i,1) to Pix(i,m), and the period during which the i-th emission control line EMi is in an inactivated state is a non-light emission period of the i-th row of pixel circuits Pix(i,1) to Pix(i,m) (i=1 to n). As illustrated in FIG. 4 described later, in the present embodiment, the first scanning signal line PSi1 is connected to the gate terminal of a P-channel type (hereinafter also referred to as “P-type”) transistor in the pixel circuit 15 (i1=1 to n), and the second scanning signal line NSi2 is connected to the gate terminal of an N-channel type (hereinafter also referred to as “N-type”) transistor in the pixel circuit 15 (i2=−1 to n). As a result, a low level voltage is applied as an active signal to the selected first scanning signal line PSi1, and a high level voltage is applied as an active signal to the selected second scanning signal line NSi2.

### 1.2 Schematic Operation

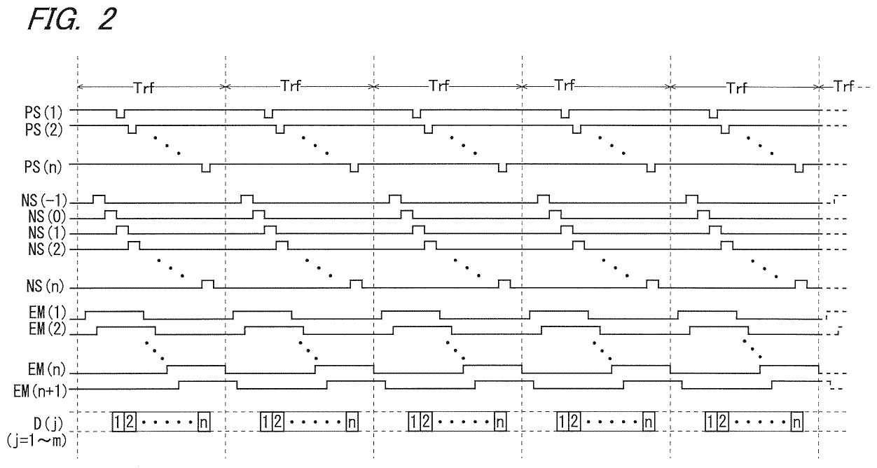

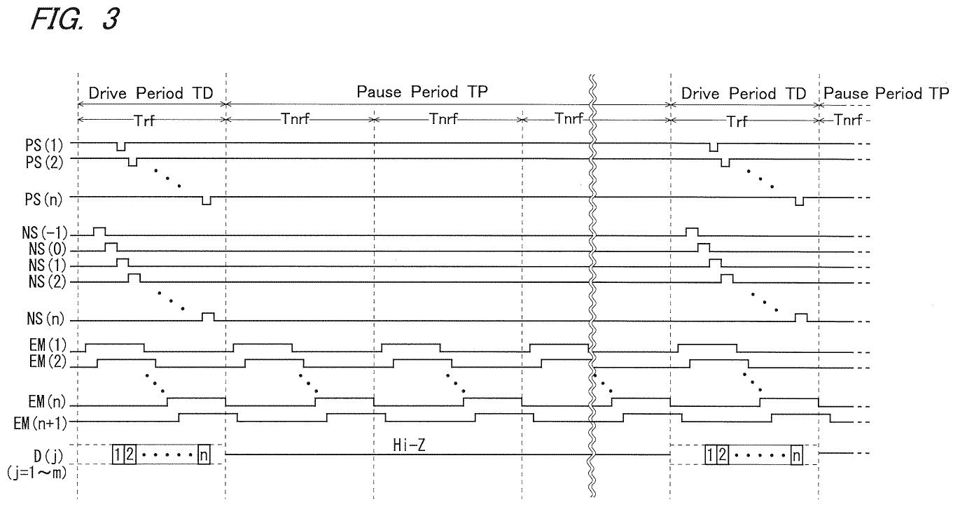

Below, with reference to FIGS. 2 and 3, the schematic operation of the display device 10 in the normal driving mode and the pause driving mode will be explained.

FIG. 2 is a timing chart for describing a schematic operation of the display device 10 in the normal driving mode. In the normal driving mode, the scanning-side drive circuit 40 generates first scanning signals PS(1), PS(2), . . . , PS(n) and second scanning signals NS(−1), NS(0), NS(1), . . . , NS(n) as illustrated in FIG. 2 based on the scanning-side control signal Scs provided from the display control circuit 20, and applies the first scanning signals PS(1) to PS(n) to the first scanning signal lines PS1 to PSn, respectively, and applies the second scanning signals NS(−1) to NS(n) to the second scanning signal lines NS−1 to NSn, respectively. Furthermore, the scanning-side drive circuit 40 generates emission control signals EM(1) to EM(n+1) as illustrated in FIG. 2 based on the scanning-side control signal Scs, and applies the emission control signals EM(1) to EM(n+1) to the emission control lines EM1 to EMn+1, respectively. On the other hand, the data-side drive circuit 30 generates data signals D(1) to D(m) that change in conjunction with the first scanning signals PS(1) to PS(n) as illustrated in FIG. 2 based on the data-side control signal Scd from the display control circuit 20, and applies the data signals D(1) to D(m) to the data signal lines D1 to Dm, respectively. In this manner, the first scanning signal lines PS1 to PSn, the second scanning signal lines NS−1 to NSn, the emission control lines EM1 to EMn+1, and the data signal lines D1 to Dm in the display portion 11 are driven, whereby during the non-light emission period, initialization and writing of a data voltage are performed for each pixel circuit Pix(i, j), and during the light emission period, each pixel circuit Pix(i, j) emits light with a luminance according to the written data voltage.

In the normal driving mode, the first scanning signal lines PS1 to PSn, the second scanning signal lines NS−1 to NSn, the emission control lines EM1 to EMn+1, and the data signal lines D1 to Dm are driven as described above by the various signals illustrated in FIG. 2, whereby a refresh frame period Trf is repeated in which the first scanning signal lines PS1 to PSn and the second scanning signal lines NS−1 to NSn are sequentially selected in one frame period to write image data to the pixel circuits Pix(1,1) to Pix(n,m) of the display portion 11.

FIG. 3 is a timing chart for describing a schematic operation of the display device 10 in the pause driving mode. In the pause driving mode, as illustrated in FIG. 3, a drive period TD consisting of the above-mentioned refresh frame period (hereinafter also referred to as the “RF frame period”) Trf and a pause period TP consisting of multiple non-refresh frame periods (hereinafter also referred to as the “NRF frame periods”) Tnrf are repeated alternately. During the pause period TP (NRF frame period Tnrf), the driving of the first scanning signal lines PS1 to PSn and the second scanning signal lines NS−1 to NSn by the scanning-side drive circuit 40 and the driving of the data signal lines D1 to Dm by the data-side drive circuit 30 are stopped, and display based on the image data written in the immediately preceding drive period TD (RF frame period Trf) continues. Therefore, the pause driving mode is effective in reducing the power consumption of the display device 10 when displaying a still image. However, as described later, there is also an embodiment in which the first scanning signal lines PS1 to PSn are driven even during the pause period TP. In the example illustrated in FIG. 3, the drive period TD is made up of only one RF frame period Trf, but it may be made up of two or more RF frame periods Trf.

The input signal Sin from the outside includes an operation mode signal Sm, which indicates whether the display portion 11 is to be driven in the normal driving mode or the pause driving mode. This operation mode signal Sm is provided to the scanning-side drive circuit 40 as a part of the scanning-side control signal Scs and is provided to the data-side drive circuit 30 as a part of the data-side control signal Scd. The scanning-side drive circuit 40 drives the first scanning signal lines PS1 to PSn and the second scanning signal lines NS−1 to NSn in accordance with the operation mode indicated by the operation mode signal Sm, and drives the emission control lines EM1 to EMn+1 in the same manner (same period and same duty) regardless of whether the display device 10 is in the normal driving mode or the pause driving mode. The data-side drive circuit 30 drives the data signal lines D1 to Dn in accordance with the operation mode indicated by this operation mode signal Sm. Note that since the object of the present application is not related to the normal driving mode, the following description of the operation of the display device 10 or its pixel circuits will be focused on the operation in the pause driving mode (the same applies to other embodiments described later).

In the present embodiment, in the RF frame period Trf, a data writing operation is performed for each pixel circuit Pix(i, j) when the corresponding first and second scanning signal lines PSi, NSi are in a selected state, and an initialization operation is performed when the second scanning signal line NSi−2 two lines before the second scanning signal line NSi is in the selected state. The emission control line EMi is driven (i=1 to n+1) (see FIG. 3) such that each pixel circuit Pix(i, j) is in a light-off state during a period in which the data writing operation and the initialization operation are performed. As described below, in the pixel circuit Pix(i, j) in the present embodiment, P-type transistors are used as the first and second emission control transistors T5, T6, so that each emission control line EMi is activated when a low-level (L-level) voltage is applied and is inactivated when a high-level (H-level) voltage is applied.

### 1.3 Configuration of Pixel Circuit

FIG. 4 is a circuit diagram illustrating a configuration of the pixel circuit 15 in the present embodiment, and more specifically, the configuration of pixel circuit 15 corresponding to the i-th first scanning signal line PSi and the j-th data signal line Dj, i. e., pixel circuit Pix(i, j) in the i-th row and j-th column (1≤i≤n, 1≤j≤m). The pixel circuit 15 includes one organic EL element OL as a display element, seven transistors T1 to T7 (hereinafter referred to as a “first initialization transistor T1”, a “threshold compensation transistor T2”, a “write control transistor T3”, a “drive transistor T4”, a “first emission control transistor T5”, a “second emission control transistor T6”, and a “second initialization transistor T7”), and one holding capacitor Cst. In addition to these elements, the pixel circuit 15 also includes a bias application circuit 151 that includes a bias application capacitor Cob.

In the pixel circuit 15, the transistors T1, T2, and T7 are N-type transistors, and the transistors T3 to T6 are P-type transistors. In the present embodiment, each of the N-type transistors T1, T2, and T7 is a thin-film transistor (hereinafter referred to as an “oxide TFT”) with a channel layer formed of an oxide semiconductor, and more specifically, is an oxide TFT (hereinafter referred to as an “IGZO-TFT”) that use indium gallium zinc oxide (InGaZnO) as the oxide semiconductor. The oxide TFT has a small off-leak current and is therefore suitable as a switching element in a pixel circuit and the like. Moreover, each of the P-type transistors T3 to T6 is a thin film transistor (hereinafter referred to as a “LTPS-TFT”) with a channel layer formed of a low-temperature polysilicon. Since low-temperature polysilicon has high mobility, when the LTPS-TFT is used as a drive transistor, the driving capability for an organic EL element in a pixel circuit is improved, and when used as a switching element, the on-resistance is reduced. However, the transistors that can be used in the pixel circuit 15 are not limited to such IGZO-TFTs or LTPS-TFTs. In the pixel circuit 15, the transistors T1 to T3 and T5 to T7 other than the drive transistor T4 operate as switching elements.

As illustrated in FIGS. 1 and 4, to a pixel circuit Pix(i, j) in the present embodiment, a first scanning signal line corresponding thereto (hereinafter, also referred to as a “corresponding first scanning signal line” in the description focusing on the pixel circuit) PSi, a second scanning signal line corresponding thereto (hereinafter, also referred to as a “corresponding second scanning signal line” in the description focusing on the pixel circuit) NSi, an emission control line corresponding thereto (hereinafter, also referred to as a “corresponding emission control line” in the description focusing on the pixel circuit) Emi, a data signal line corresponding thereto (hereinafter, also referred to as a “corresponding second scanning signal line” in the description focusing on the pixel circuit) Dj, a second scanning signal line NSi−2 that is two lines before the corresponding second scanning signal line NSi (the scanning signal line NSi−2 that is two lines before in the scanning order of the second scanning signal lines NS−1 to NSn; hereinafter, in the description focusing on the pixel circuits, it is also simply referred to as a “preceding second scanning signal line”), the initialization voltage line Vini, the high-level power supply line ELVDD, and the low-level power supply ELVSS are connected, and further, an emission control line EMi+X that succeeds the corresponding emission control line EMi is connected. Note that a configuration may be used in which the immediately preceding second scanning signal line NSi−1 is connected to the pixel circuit Pix(i, j) instead of the preceding second scanning signal line NSi−2.

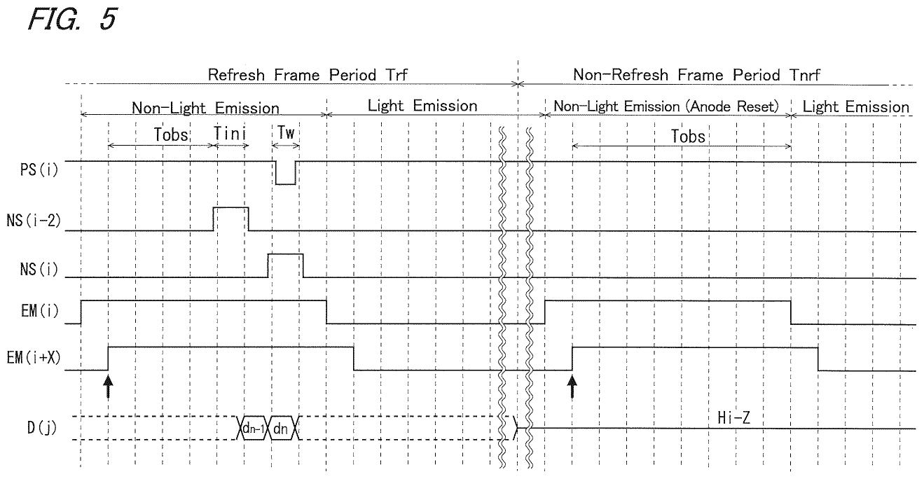

In the present embodiment, X, which specifies the subsequent emission control line EMi+X connected to the pixel circuit Pix(i, j), is an integer of 0 or more and is selected such that in the RF frame period Trf, the emission control signal EM(i+X) of the subsequent emission control line EMi+X changes from L level to H level in a period from when the corresponding emission control line EMi for the pixel circuit Pix(i, j) changes to the inactive state until when data writing accompanied by threshold compensation is started (see FIG. 5, which will be described later). However, as described later, X is preferably an integer of 1 or more. In addition, “until data writing accompanied by threshold compensation is started” corresponds to “until the write control transistor T3 changes to ON state as a result of the corresponding first scanning signal PS(i) changing to L level.” However, it is preferable to select X such that the emission control signal EM(i+X) of the subsequent emission control line EM i+X changes from L level to H level before the threshold compensation transistor T2 changes to ON state as a result of the corresponding second scanning signal NS(i) changing to H level.

In the following description of such a pixel circuit Pix(i, j), the signal PS(i) of the corresponding first scanning signal line PSi, the signal NS(i) of the corresponding second scanning signal line NSi, the signal NS(i−2) of the preceding second scanning signal line NSi−2, the signal EM(i) of the corresponding emission control line EMi, the signal EM(i+X) of the subsequent emission control line EMi+X, and the signal D(j) of the corresponding data signal line Dj will be referred to as the corresponding first scanning signal PS(i), the corresponding second scanning signal NS(i), the preceding second scanning signal NS(i−2), the corresponding emission control signal EM(i), the subsequent emission control signal EM(i+X), and the corresponding data signal D(j), respectively.

As illustrated in FIG. 4, in the pixel circuit Pix(i, j), the drive transistor T4 has a source terminal connected to the corresponding data signal line Dj via the write control transistor T3 and connected to the high-level power supply line ELVDD via the first emission control transistor T5. The drive transistor T4 also has a drain terminal connected to an anode serving as a first terminal of the organic EL element OL via the second emission control transistor T6, and a cathode serving as a second terminal of the organic EL element OL is connected to the low-level power supply line ELVSS. The drive transistor T4 further has a gate terminal connected to the drain terminal of the drive transistor T4 via the threshold compensation transistor T2, connected to the high-level power supply line ELVDD via the holding capacitor Cst, and connected to the initialization voltage line Vini via the first initialization transistor T1. The anode of the organic EL element OL is also connected to the initialization voltage line Vini via the second initialization transistor T7 serving as a display element initialization transistor. The bias application circuit 151 has a first terminal connected to the subsequent emission control line EMi+X and a second terminal connected to the source terminal of the drive transistor T4, and includes the bias application capacitor Cob described above, and the first terminal is connected to the second terminal via the bias application capacitor Cob.

### 1.4 Operation of Pixel Circuit in Pause Driving Mode

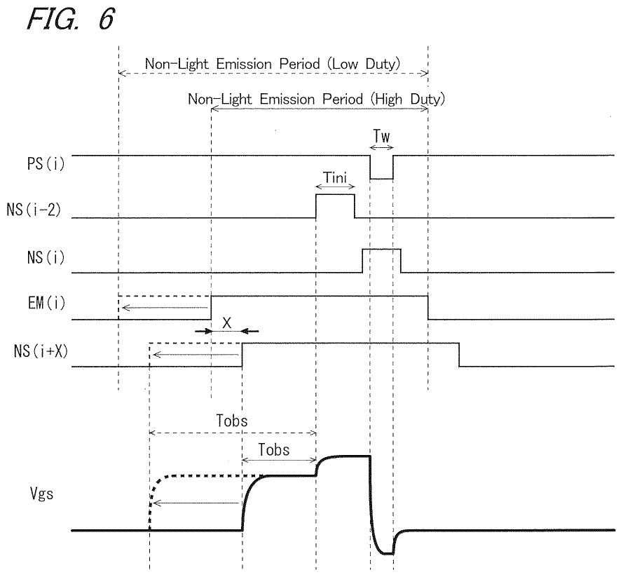

The operation of the pixel circuit 15 illustrated in FIG. 4, that is the pixel circuit Pix(i, j) of the i-th row and j-th column in the present embodiment will be described below with reference to FIGS. 4 and 5. FIG. 5 is a timing chart for describing the operation of the pixel circuit Pix(i, j) in the non-light emission period included in the RF frame period Trf and the NRF frame period Tnrf. In FIG. 5, a plurality of dotted lines extending in the vertical direction are drawn, and the interval between these dotted lines corresponds to one horizontal period. Furthermore, the period during which the emission control signal EM(i) is at H level is a non-light emission period, and the period during which the emission control signal EM(i) is at L level is a light emission period (the same applies to the timing charts in FIGS. 6, 8, 10, and 14, which will be described later).

First, the operation of the pixel circuit Pix(i, j) in the non-light emission period in the RF frame period Trf will be described. As illustrated in FIG. 5, at the start of the non-light emission period (the period during which the corresponding emission control signal EM(i) is at H level), the corresponding first scanning signal PS(i) is at H level, and the preceding second scanning signal NS(i−2) and the corresponding second scanning signal NS(i) are at L level. During the non-light emission period, the first and second emission control transistors T5 and T6 are in OFF state, so that the organic EL element OL is in the light-off state, and the second initialization transistor T7 is in ON state, so that the anode of the organic EL element OL is initialized.

As illustrated in FIG. 5, in the non-light emission period, first, the preceding second scanning signal NS(i−2) is at H level for a predetermined period corresponding to approximately one horizontal period, and during this predetermined period (hereinafter referred to as the “initialization period Tini”), the first initialization transistor T1 is in ON state, so that the voltage of the holding capacitor Cst and the gate terminal of the drive transistor T4 (hereinafter referred to as the “gate voltage”) is initialized to the initialization voltage Vini.

Thereafter, during the non-light emission period, the corresponding second scanning signal NS(i) is at H level for a predetermined period corresponding to approximately one horizontal period, and within this predetermined period, the corresponding first scanning signal PS(i) is at L level for a predetermined period corresponding to approximately one horizontal period. Here, a period during which the corresponding second scanning signal NS(i) is at H level and the corresponding first scanning signal PS(i) is at L level will be referred to as a “compensation/write period Tw” or simply as a “write period Tw.” During the write period Tw, the threshold compensation transistor T2 is in ON state, causing the drive transistor T4 to be in a diode-connected state, and the write control transistor T3 is in ON state, causing a voltage Vdata of the corresponding data signal D(j) to be written to the holding capacitor Cst via the drive transistor T4 in the diode-connected state. As a result, the gate terminal of the drive transistor T4 is held at a data voltage (Vdata−|Vth|) after threshold compensation. Here, Vth is a threshold voltage of the drive transistor T4.

A subsequent emission control signal EM(i+X) is provided to the first terminal of the bias application circuit 151. As described above, X specifying the subsequent emission control line EMi+X is an integer of 0 or more and is selected such that in the RF frame period Trf, the subsequent emission control signal EM(i+X) changes from L level to H level in the period from when the corresponding emission control line EMi for the pixel circuit Pix(i, j) changes to the inactive state until when data writing accompanied by threshold compensation is started; in the example illustrated in FIG. 5, X=1. At the time when such a subsequent emission control signal EM(i+X) changes to H level, the write control transistor T3, the first and second emission control transistors T5, T6, and the threshold compensation transistor T2 are all in OFF state, and the node NdS including the source terminal of the drive transistor T4 is in a floating state, so that the voltage of the source terminal (hereinafter also referred to as the “source voltage”) Vs changes in the same direction as the change of the subsequent emission control signal EM(i+X) from L level to H level. That is, the source voltage Vs of the drive transistor T4 rises in response to the change of the subsequent emission control signal EM(i+X) from L level to H level. In addition, the increase in the source voltage Vs can be made approximately equal to the voltage difference between L level and H level in the subsequent emission control signal EM(i+X) by setting the capacitance of the bias application capacitor Cob to be sufficiently larger than the parasitic capacitance added to the node NdS.

In the RF frame period Trf, the above-described operation causes a relatively large voltage stress (Vgs) to be applied to the drive transistor T4 from a point when the subsequent emission control signal EM(i+X) changes from L level to H level (see the upward arrow in FIG. 5) until the start point of the initialization period Tini (the point when the preceding second scanning signal NS(i−2) changes to H level). In the present embodiment, the period during which a relatively large voltage stress (Vgs) is applied to the drive transistor T4 in this manner is an on-bias application period Tobs. Similar to an on-bias application period Tobs in the NRF frame period Tnrf, which will be described later, the end point of the on-bias application period Tobs does not depend on the light emission duty, and the length thereof becomes longer as the light emission duty becomes lower. This will be described below with reference to FIG. 6.

FIG. 6 is a timing chart for describing the relationship between the on-bias application period Tobs and the light emission duty in the RF frame period Trf. In the present embodiment, as illustrated in FIG. 6, the light emission duty is adjusted by changing the rising timing of the emission control signal EM(i) (this also applies to other embodiments described later). For this reason, when the light emission duty is low (when the brightness is set to low), the rise timing of the emission control signal EM(i) is earlier, and accordingly the rise timing of the subsequent emission control signal EM(i+X) is also earlier, so that the period Tobs during which a relatively large on-bias voltage Vobs (voltage stress Vgs) is applied to the drive transistor T4 becomes longer. In this manner, in the present embodiment, in the RF frame period Trf, the lower the light emission duty, the longer the on-bias application period Tobs. This also applies to the NRF frame period Tnrf. Furthermore, in the present embodiment, in each pixel circuit Pix(i, j), there is no need to provide a write period Tw between the rising edges of the corresponding emission control signal EM(i) and the subsequent emission control signal EM(i+X). Instead, the subsequent emission control signal EM(i+X) changes from L level to H level during the period from when the corresponding emission control line EMi changes to the inactive state until when data writing is started, resulting in a state in which a relatively large voltage stress (Vgs) is applied to the drive transistor T4. Therefore, by selecting a small value for X, it is possible to apply a relatively large voltage stress (Vgs) for a long period of time. The present embodiment having such a configuration is advantageous in narrowing a frame of the display device.

As described above, the data voltage Vdata is written in the write period Tw after the on-bias application period Tobs, and the gate terminal of the drive transistor T4 is thereby held at the data voltage (Vdata−|Vth|) after threshold compensation.

Thereafter, the corresponding emission control signal EM(i) changes to L level, thereby starting the light emission period. During this light emission period, the first and second emission control transistors T5 and T6 are in ON state, and the other transistors T1, T2, T3, and T7 except for the drive transistor T4 are in OFF state. As a result, a current I1 corresponding to the data voltage Vdata written in the holding capacitor Cst flows through the organic EL element OL, and the organic EL element OL emits light with a luminance corresponding to the current I1.

Next, the operation of the pixel circuit Pix(i, j) in the non-light emission period in the NRF frame period Tnrf will be described. During the NRF frame period Tnrf, the driving of the first scanning signal lines PS1 to PSn and the second scanning signal lines NS−1 to NSn is stopped, so that, as illustrated in FIG. 5, the corresponding first scanning signal PS(i) is maintained at H level, and the preceding second scanning signal NS(i−2) and the corresponding second scanning signal NS(i) are maintained at L level. Even in the NRF frame period Tnrf, during the non-light emission period, the first and second emission control transistors T5, T6 are in OFF state, so that the organic EL element OL is in the light-off state, and the second initialization transistor T7 is in ON state, so that the anode of the organic EL element OL is initialized.

As illustrated in FIG. 5, after the corresponding emission control signal EM(i) changes from L level to H level to start the non-light emission period, the subsequent emission control signal EM(i+X) changes from L level to H level. In the example illustrated in FIG. 5, the subsequent emission control signal EM(i+X) changes to H level one horizontal period after the corresponding emission control signal EM(i) changes to H level. The subsequent emission control signal EM(i+X) is provided to the first terminal of a bias application circuit 151, and as illustrated in FIG. 4, the first terminal is connected to the source terminal of the drive transistor T4 via the bias application capacitor Cob. Furthermore, at the time when the subsequent emission control signal EM(i+X) changes to H level, the write control transistor T3, the first and second emission control transistors T5, T6, and the threshold compensation transistor T2 are all in OFF state, and the node NdS including the source terminal of the drive transistor T4 is in the floating state. Therefore, the voltage (source voltage) Vs of the source terminal of the drive transistor T4 changes in the same direction as the change of the subsequent emission control signal EM(i+X) from L level to H level. That is, the source voltage Vs of the drive transistor T4 rises in response to the change of the subsequent emission control signal EM(i+X) from L level to H level. The source voltage Vs whose level has been raised in this manner is maintained until the corresponding emission control signal EM(i) changes to L level (until the end of the non-light emission period). Therefore, in the NRF frame period Tnrf, the period from when the subsequent emission control signal EM(i+X) changes to H level until when the corresponding emission control signal EM(i) changes to L level is called the “on-bias application period Tobs.” During the NRF frame period Tnrf, the first initialization transistor T1, the threshold compensation transistor T2, and the write control transistor T3 are maintained in OFF state (see FIGS. 4 and 5). Moreover, the data signals D(1) to D(m) applied to the data signal lines D1 to Dm are all maintained in a high impedance state.

Thereafter, the corresponding emission control signal EM(i) changes to L level, and the light emission period is started. In the light emission period, the pixel circuit Pix(i, j) operates in the same manner as in the light emission period in the RF frame period Trf.

As described above, in the pixel circuit Pix(i, j) in the present embodiment, when the non-light emission period is started in the NRF frame period Tnrf, the source voltage Vs, the level of which has increased due to the change of the subsequent emission control signal EM(i+X) to H level, is applied as the on-bias voltage to the source terminal of the drive transistor T4 during the on-bias application period Tobs. As a result, after the on-bias voltage is applied, a relatively large voltage stress (Vgs) is applied to the drive transistor T4 until the start of the light emission period. Therefore, as can be seen by referring to FIG. 6, which illustrates the voltage stress (Vgs) applied to the drive transistor T4 during the RF frame period Trf, together with FIG. 5, in the configuration in which the light emission duty is adjusted by changing the rising timing of the emission control signal EM(i), i.e., the start timing of the non-light emission period, the difference in the stress state of the drive transistor T4 between the RF frame period Trf and the NRF frame period Tnrf is reduced regardless of the light emission duty.

### 1.5 Effects

According to the present embodiment described above, as can be seen from FIGS. 5 and 6, in the configuration in which the light emission duty is adjusted by changing the start timing of the non-light emission period, the difference in the stress state of the drive transistor T4 between the RF frame period Trf and the NRF frame period Tnrf is reduced regardless of the light emission duty. As a result, the luminance difference between the RF frame period Trf and the NRF frame period Tnrf is reduced, and flicker is not visible even when pause driving is performed with a low light emission duty. That is, according to the present embodiment, when pause driving is performed, a flicker suppression effect that does not depend on the light emission duty can be obtained. In addition, a period during which the voltage stress (Vgs) on the drive transistor T4 becomes a small value (Vth) when data is written in the RF frame period Trf is about one horizontal period long and is relatively very short, so that the reduction in the stress voltage (Vgs) during that period does not pose a problem in terms of suppressing flicker as described above. Furthermore, in the present embodiment, since there is no need for a separate voltage line or control line for applying the on-bias voltage to the drive transistor T4, it is possible to obtain such a flicker suppression effect in pause driving without complicating the configuration or driving of the pixel circuit.

### 2. Second Embodiment

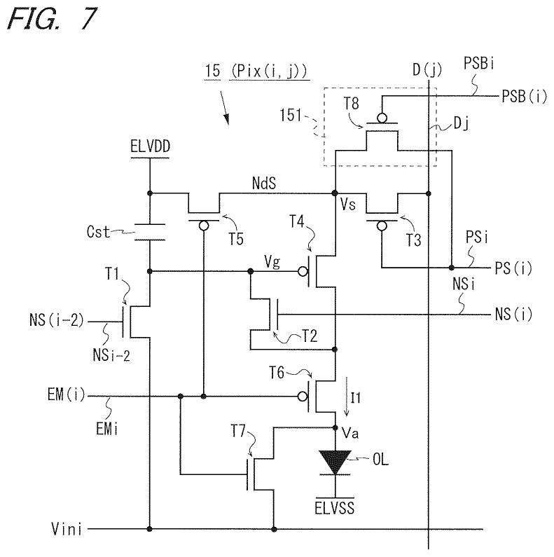

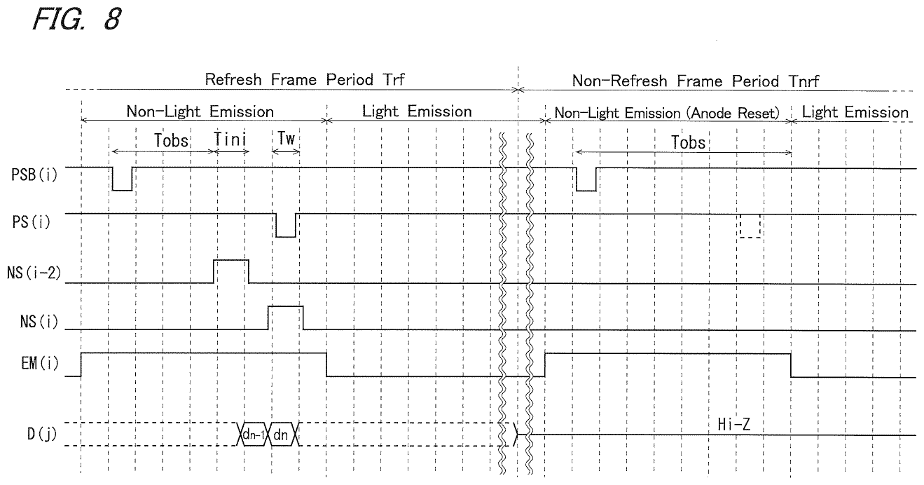

Next, an organic EL display device according to a second embodiment will be described with reference to FIGS. 7 and 8. Note that configurations of the present embodiment that are not newly described below are the same as those of the first embodiment (see FIGS. 1 and 4). In the display device according to the present embodiment, n signal lines for bias control (hereinafter referred to as “bias control lines”) PSB1 to PSBn are arranged along the n first scanning signal lines PS1 to PSn, respectively. Each pixel circuit 15 corresponds to one of the n bias control lines PB1 to PBn. In addition, in the present embodiment, the scanning-side drive circuit 40 also functions as a bias control circuit that drives the bias control lines PB1 to PBn by generating the bias control signals PSB(1) to PSB(n) described below in the pause driving mode and applying the bias control signals PSB(1) to PSB(n) to the bias control lines PB1 to PBn, respectively (see FIG. 8). In the normal driving mode, the driving of the bias control lines PSB1 to PSBn is stopped, and all of the bias control lines PSB1 to PSBn are maintained in an inactive state.

FIG. 7 is a circuit diagram illustrating a configuration of a pixel circuit Pix(i, j) in the i-th row and j-th column, which is a pixel circuit 15 in the present embodiment (1≤i≤n, 1≤j≤m). The pixel circuit 15 has the same configuration as the pixel circuit 15 in the first embodiment (FIG. 4), except for a configuration of the bias application circuit 151.

As illustrated in FIG. 7, a pixel circuit Pix(i, j) in the i-th row and j-th column, which is a pixel circuit 15 in the present embodiment, is connected to a corresponding first scanning signal line PSi, a bias control line PSBi corresponding to the pixel circuit Pix(i, j) (hereinafter, in the description focusing on the pixel circuit, it will also be referred to as the “corresponding bias control line”), a corresponding second scanning signal line NSi, a preceding second scanning signal line NSi−2, a corresponding emission control line EMi, a corresponding data signal line Dj, an initialization voltage line Vini, a high-level power supply line ELVDD, and a low-level power supply line ELVSS. In addition, the bias application circuit 151 provided in this pixel circuit 15 has a first terminal connected to the corresponding first scanning signal line PSi and receiving the voltage of the corresponding first scanning signal PS(i) in the inactive state as the on-bias voltage, and a second terminal connected to the source terminal of the drive transistor T4, and includes a P-type bias application transistor T8 having a source terminal and a drain terminal connected to the first and second terminals, respectively. The bias application transistor T8 has a gate terminal connected to the corresponding bias control line PSBi and operates as a switching element.

Next, the operation of the pixel circuit Pix(i, j) illustrated in FIG. 7 will be described with reference to FIG. FIG. 8 is a timing chart for describing the operation of the pixel circuit Pix(i, j) in the non-light emission period included in the RF frame period Trf and the NRF frame period Tnrf.

As can be seen by comparing FIG. 8 with FIG. 5, in the RF frame period Trf, the first scanning signal PS(i), the second scanning signals NS(i), NS(i−2), the emission control signal EM(i), and the data signal D(j) for driving the pixel circuit Pix(i, j) in the present embodiment change in the same manner as the first scanning signal PS(i), the second scanning signals NS(i), NS(i−2), the emission control signal EM(i), and the data signal D(j) for driving the pixel circuit Pix(i, j) in the first embodiment described above. Therefore, during the RF frame period Trf, the transistors T1 to T3, T5 to T7 as switching elements included in the pixel circuit 15 in the present embodiment operate in the same manner as the transistors T1 to T3, T5 to T7 as switching elements included in the pixel circuit 15 in the first embodiment described above, thereby performing the same initialization operation and data writing operation. Thereafter, when the corresponding emission control signal EM(i) changes to L level, the light emission period is started, and similarly to the first embodiment described above, the organic EL element OL emits light with a luminance according to the data voltage Vdata written to the holding capacitor by the data write operation.

As illustrated in FIG. 8, in the present embodiment, during the non-light emission period in the RF frame period Trf, from when the corresponding emission control signal EM(i) changes from L level to H level to start the non-light emission period to when the preceding second scanning signal NS(i−2) changes from L level to H level to start the initialization period Tini, the corresponding bias control signal PSB(i) is at L level for a predetermined period. During the predetermined period, the voltage of the corresponding first scanning signal line PSi is applied as the on-bias voltage to the source terminal of the drive transistor T4 via the bias application transistor T8. Thereafter, the corresponding bias control signal PSB(i) changes to H level to turn off the bias application transistor T8. However, the voltage at the source terminal of the drive transistor T4 (source voltage Vs) is maintained until the corresponding second scanning signal NS(i) changes to H level to turn on the threshold compensation transistor T2. Furthermore, until the preceding second scanning signal NS(i−2) changes to H level to turn on the first initialization transistor T1, the voltage of the gate terminal of the drive transistor T4 (gate voltage Vg) is maintained at a voltage corresponding to the holding voltage of the holding capacitor Cst. Therefore, during a period from when the corresponding bias control signal PSB(i) changes to L level until when the preceding second scanning signal NS(i−2) changes to H level to start the initialization period Tini, a relatively large voltage stress (Vgs) based on H level voltage of the corresponding first scanning signal PS(i) is applied to the drive transistor T4. In the present embodiment, this period in the RF frame period Trf is called the “on-bias application period Tobs.”

The operation of the pixel circuit Pix(i, j) after the initialization period Tini in the RF frame period Trf is the same as that in the first embodiment.

Next, the operation of the pixel circuit Pix(i, j) in the non-light emission period in the NRF frame period Tnrf will be described. As illustrated in FIG. 8, at the start of the non-light emission period, as in the case of the above-mentioned RF frame period Trf, the corresponding first scanning signal PS(i) is at H level, and the preceding second scanning signal NS(i−2) and the corresponding second scanning signal NS(i) are at L level. During the non-light emission period, the first and second emission control transistors T5 and T6 are in OFF state, so that the organic EL element OL is in the light-off state, and the second initialization transistor T7 is in ON state, so that the anode of the organic EL element OL is initialized. During the NRF frame period Tnrf, the corresponding bias control signal PSB(i) changes in the same manner as during the RF frame period Trf. However, during the NRF frame period Tnrf, the first scanning signal PS(i) is maintained at H level, and the preceding second scanning signal NS(i−2) and the corresponding second scanning signal NS(i) are maintained at L level. While the corresponding bias control signal PSB(i) is at L level, the bias application transistor T8 is in ON state, and during this L level period, the voltage of the corresponding first scanning signal line PSi is applied as the on-bias voltage to the source terminal of the drive transistor T4 via the bias application transistor T8. Thereafter, the corresponding bias control signal PSB(i) changes to H level to turn off the bias application transistor T8. However, the source terminal of the drive transistor T4 is in the floating state until the corresponding emission control signal EM(i) goes to L level to turn on the first and second emission control transistors T5, T6, and the voltage Vg of the gate terminal of the drive transistor T4 becomes a voltage corresponding to the voltage Vdata written to the holding capacitor Cst. For this reason, during the period from when the corresponding bias control signal PSB(i) changes to L level until the corresponding emission control signal EM(i) changes to L level to start the light emission period, a relatively large voltage stress (Vgs) based on H level voltage of the corresponding first scanning signal PS(i) is applied to the drive transistor T4. Therefore, in the present embodiment, this period in the NRF frame period Tnrf is also called the “on-bias application period Tobs.”

Thereafter, the corresponding emission control signal EM(i) changes to L level, and the light emission period is started. The operation of the pixel circuit Pix(i, j) during the light emission period in the NRF frame period Tnrf is similar to that in the first embodiment.

In the present embodiment as described above, similarly to the first embodiment, flicker is suppressed even when pause driving is performed, regardless of the light emission duty. Moreover, since there is no need for a separate voltage line for applying the on-bias voltage to the drive transistor T4, it is possible to obtain such a flicker suppression effect in pause drive while preventing the complication of the pixel circuit configuration and drive.

In the present embodiment, in each pixel circuit Pix(i, j), a corresponding bias control line PSBi is connected to the gate terminal of the bias application transistor T8 that constitutes the bias application circuit 151, and ON/OFF of the bias application transistor T8 is controlled by a corresponding bias control signal PSB(i). However, by appropriately setting X for a first scanning signal PS(i−X) (X is an integer of two or more) preceding a corresponding first scanning signal PS(i), the preceding first scanning signal PS(i−X) can be used as the corresponding bias control signal PSB(i). Note that in this case, the first scanning signal PS(i) is generated such that the first scanning signal PS(i) is at L level for a predetermined period even during the non-refresh period in the NRF frame period, as shown by the dotted line in FIG. 8. According to such a configuration, it is possible to obtain the above-mentioned effects with a simpler configuration without providing a circuit for generating the bias control signals PSB(1) to PSB(n) or the bias control lines PSB1 to PSBn.

In addition, in the present embodiment, in each pixel circuit Pix(i, j), a corresponding first scanning signal line PSi is connected to the first terminal of the bias application circuit 151, and H level voltage of the corresponding first scanning signal PS(i) is applied to the bias application circuit 151 as the on-bias voltage. However, another signal line may be connected to the first terminal as long as the another signal line has a voltage that can be used as the on-bias voltage while the bias application transistor T8 is in ON state in the on-bias application period Tobs. For example, instead of the corresponding first scanning signal line PSi, the corresponding emission control line EMi may be connected to the first terminal of the bias application circuit 151.

### 3. Third Embodiment

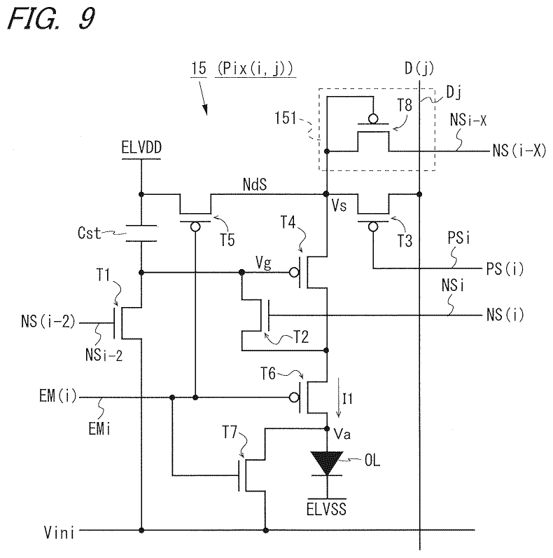

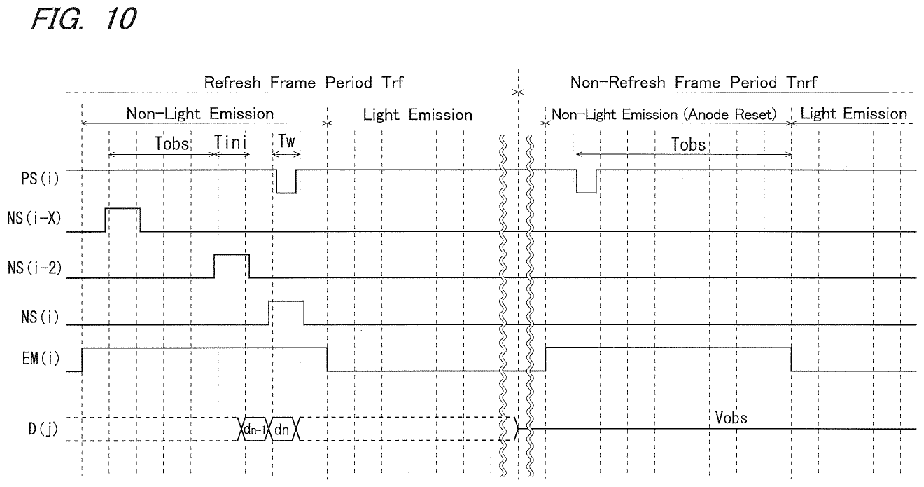

Next, an organic EL display device according to a third embodiment will be described with reference to FIGS. 9 and 10. Note that configurations of the present embodiment that are not newly described below are the same as those of the first embodiment (see FIGS. 1 and 4).

### 3.1 First Configuration Example

FIG. 9 is a circuit diagram illustrating a first configuration example of a pixel circuit 15 in the present embodiment, and more specifically, circuit diagram illustrating the configuration of the pixel circuit Pix(i, j) in the i-th row and j-th column (1≤i≤n, 1≤j≤m). The pixel circuit 15 has the same configuration as the pixel circuit 15 in the first embodiment (FIG. 4), except for the configuration of the bias application circuit 151.

As illustrated in FIG. 9, a pixel circuit Pix(i, j) in the i-th row and j-th column, which is a pixel circuit 15 in the present embodiment, is connected to a corresponding first scanning signal line PSi, a corresponding second scanning signal line NSi, a preceding second scanning signal line NSi−2, a corresponding emission control line EMi, a corresponding data signal line Dj, an initialization voltage line Vini, a high-level power supply line ELVDD, and a low-level power supply line ELVSS, and is further connected to a preceding second scanning signal line NSi−X. Here, X is a positive integer and is selected such that in the RF frame period Trf, a period during which the second scanning signal NS(i−X) of the preceding second scanning signal line NSi−X is at H level is included from when the corresponding emission control line EMi for the pixel circuit Pix(i, j) changes to the inactive state until when data writing accompanied by threshold compensation is started (see FIG. 10 described later). However, X is preferably an integer of 2 or more. In addition, “until when data writing accompanied by threshold compensation is started” corresponds to “until when the write control transistor T3 changes to ON state as a result of the corresponding first scanning signal PS(i) changing to L level.” However, it is preferable to select X such that the second scanning signal NS(i−X) of the preceding second scanning signal line NSi−X changes from H level to L level before the threshold compensation transistor T2 changes to ON state as a result of the corresponding second scanning signal NS(i) changing to H level. In the following description focusing on the pixel circuit Pix(i, j), the preceding second scanning signal line NSi−X specified by such X will be referred to as the “bias control second scanning signal line NSi−X,” and the signal of the bias control second scanning signal line NSi−X will be referred to as the “bias control second scanning signal NS(i−X)” (the same applies to other embodiments described later).

As illustrated in FIG. 9, the bias application circuit 151 provided in the pixel circuit 15 according to the present configuration example has a first terminal connected to the bias control second scanning signal line NSi−X and receiving the voltage of the bias control second scanning signal NS(i−X) as the on-bias voltage Vobs, and a second terminal connected to the source terminal of the drive transistor T4, and includes a P-type bias application transistor T8 having a source terminal and a drain terminal connected to the first and second terminals, respectively. The bias application transistor T8 has its gate terminal connected to its drain terminal, thereby forming a diode connection.

Next, the operation of the pixel circuit Pix(i, j) in the i-th row and j-th column according to the present configuration example illustrated in FIG. 9 will be described with reference to FIG. 10. FIG. 10 is a timing chart for describing the operation of the pixel circuit Pix(i, j) in the respective non-light emission periods included in the RF frame period Trf and the NRF frame period Tnrf.

As can be seen by comparing FIG. 10 with FIG. 5, in the RF frame period Trf, the first scanning signal PS(i), the second scanning signals NS(i), NS(i−2), the emission control signal EM(i), and the data signal D(j) for driving the pixel circuit Pix(i, j) in the present embodiment change in the same manner as the first scanning signal PS(i), the second scanning signals NS(i), NS(i−2), the emission control signal EM(i), and the data signal D(j) driving the pixel circuit Pix(i, j) in the first embodiment described above. As a result, the transistors T1 to T3, T5 to T7 as switching elements included in the pixel circuit Pix(i, j) in the present embodiment operate in the same manner as the transistors T1 to T3, T5 to T7 as switching elements included in the pixel circuit 15 in the first embodiment, thereby performing the same initialization operation and data writing operation.

As illustrated in FIG. 9, in the pixel circuit Pix(i, j) according to the present configuration example, the bias application circuit 151 receives the bias control second scanning signal NS(i−X) at its first terminal. This first terminal is connected to the source terminal of the drive transistor T4 via a P-type bias application transistor T8 in a diode connection configuration as illustrated in FIG. 9. Thus, when the bias control second scanning signal NS(i−X) is at H level, H level voltage is applied to the source terminal of the drive transistor T4 via the bias application transistor T8.

Since the value of X specifying the bias control second scanning signal NS(i−X) is selected as described above, typically from when the corresponding emission control signal EM(i) changes to H level to start the non-light emission period to when the preceding second scanning signal NS(i−2) changes to H level to start the initialization period Tini, the bias control second scanning signal NS(i−X) is at H level for a predetermined period as illustrated in FIG. 10. Thereafter, the bias control second scanning signal NS(i−X) changes to L level to turn off the bias application transistor T8. However, until the preceding second scanning signal NS(i−2) changes to H level to start the initialization period Tini, a relatively large voltage stress (Vgs) based on H level voltage of the bias control second scanning signal NS(i−X) is applied to the drive transistor T4. Therefore, in the present embodiment, the period from when the bias control second scanning signal NS(i−X) changes to H level until when the initialization period Tini is started in the RF frame period Trf is called the “on-bias application period Tobs.” The operation of the pixel circuit Pix(i, j) after the initialization period Tini in the RF frame period Trf is the same as that in the first embodiment.

In the NRF frame period Tnrf in the present embodiment, the corresponding first scanning signal line PSi is driven as illustrated in FIG. 10, and the corresponding data signal line Dj is driven such that the on-bias voltage Vobs is provided from the corresponding data signal line Dj to the source terminal of the drive transistor T4 via the write control transistor T3 during the selection period of the corresponding first scanning signal line PSi (the period during which the corresponding first scanning signal PS(i) is at L level). As a result, in the non-light emission period of the NRF frame period Tnrf, from when the corresponding first scanning signal PS(i) changes to L level until when the corresponding emission control signal EM(i) changes to L level to start the light emission period, a relatively large voltage stress (Vgs) based on the on-bias voltage Vobs provided from the corresponding data signal line Dj during the selection period of the first scanning signal PS(i) is applied to the drive transistor T4. In the NRF frame period Tnrf in the present embodiment, this period is the “on-bias application period Tobs.”

Thereafter, the corresponding emission control signal EM(i) changes to L level, and the light emission period is started. The operation of the pixel circuit Pix(i, j) during the light emission period in the NRF frame period Tnrf is the same as that in the first embodiment.

In the present embodiment as described above, by appropriately selecting X that specifies the bias control second scanning signal NS(i−X) and appropriately setting the selection period of the corresponding first scanning signal line PSi in the NRF frame period Tnrf, flicker can be suppressed regardless of the light emission duty even when pause driving is performed, as in the first embodiment described above. Also in the present embodiment, since there is no need for a separate control line or voltage line for applying the on-bias voltage to the drive transistor T4, it is possible to obtain such a flicker suppression effect while preventing the complication of the pixel circuit configuration and driving.

### 3.2 Second Configuration Example

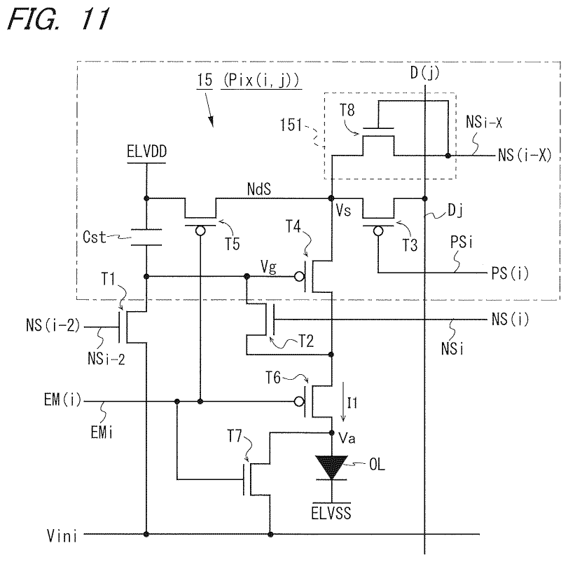

FIG. 11 is a circuit diagram illustrating a second configuration of the pixel circuit 15 in the present embodiment, and more specifically, is a circuit diagram illustrating the configuration of pixel circuit Pix(i, j) in the i-th row and j-th column (1≤i≤n, 1≤j≤m). This pixel circuit 15 differs from the pixel circuit 15 (FIG. 9) according to the first configuration example in that the bias application transistor T8 in the bias application circuit 151 is an N-type transistor, but the other configurations are the same as those of the first configuration example. In the present configuration example, the drain terminal and source terminal of the bias application transistor T8 are connected to the first and second terminals of the bias application circuit 151, respectively, and the bias application transistor T8 has its gate terminal connected to its drain terminal to form a diode connection.

The pixel circuit Pix(i, j) according to the present configuration example is driven by the first scanning signal PS(i), the second scanning signals NS(i), NS(i−2), NS(i−X), the emission control signal EM(i), and the data signal D(j), which change as illustrated in FIG. 10, and also operates in the same manner as the pixel circuit Pix(i, j) according to the first configuration example described above. Therefore, even when the pixel circuit Pix(i, j) according to the present configuration example is used in the present embodiment, the same effects as when the pixel circuit Pix(i, j) according to the first configuration example is used is obtained.

### 4. Fourth Embodiment

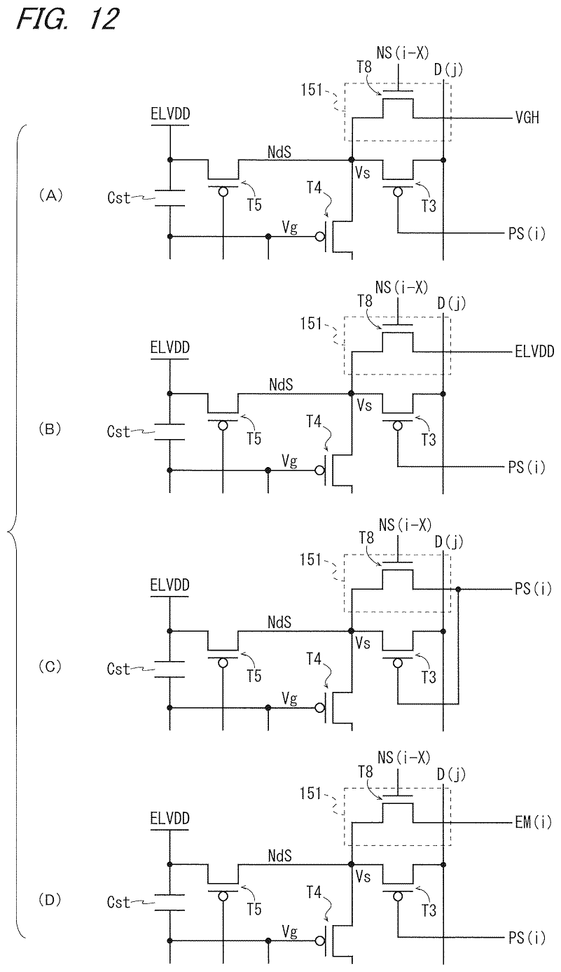

Next, with reference to FIG. 12, an organic EL display device according to a fourth embodiment will be described. Note that configurations of the present embodiment that are not newly described below are the same as those of the third embodiment (see FIGS. 1, 10, and 11).

(A) to (D) of FIG. 12 are circuit diagrams for describing first to fourth configuration examples of a pixel circuit in the present embodiment, respectively, and each diagram illustrates a configuration of a part surrounded by a dotted line in the pixel circuit 15 illustrated in FIG. 11. Each of the pixel circuits 15 according to the first to fourth configuration examples in the present embodiment has the same configuration as the pixel circuit 15 according to the second configuration example in the third embodiment (FIG. 11) except for the bias application circuit 151.

As illustrated in (A) to (D) of FIG. 12, the bias application circuit 151 provided in each of the pixel circuits 15 according to the first to fourth configuration examples has a first terminal that receives the on-bias voltage Vobs and a second terminal connected to the source terminal of the drive transistor T4 and includes an N-type bias application transistor T8 having a drain terminal and a source terminal connected to the first and second terminals, respectively. In each of the first to fourth configuration examples, the bias application transistor T8 has a gate terminal connected to the bias control second scanning signal line NSi−X, and operates as a switching element. The positive integer X specifying the bias control second scanning signal line NSi−X is selected in the same manner as in the third embodiment.

As illustrated in (A) of FIG. 12, in the pixel circuit 15 according to the first configuration example, a voltage line (hereinafter referred to as a “gate high level voltage line”) for supplying H level voltage VGH of the first scanning signal PS(i) or the second scanning signal NS(i), etc., is connected to the first terminal of bias application circuit 151, and the voltage VGH is provided as the on-bias voltage Vobs. As illustrated in (B) of FIG. 12, in the pixel circuit 15 according to the second configuration example, the high-level power supply line ELVDD is connected to the first terminal of the bias application circuit 151, and the high-level power supply voltage ELVDD is provided as the on-bias voltage Vobs. As illustrated in (C) of FIG. 12, in the pixel circuit 15 according to the third configuration example, the corresponding first scanning signal line PSi is connected to the first terminal of the bias application circuit 151, and H level voltage of the corresponding first scanning signal PS(i) is provided as the on-bias voltage Vobs. As illustrated in (D) of FIG. 12, in the pixel circuit 15 according to the fourth configuration example, the first terminal of the bias application circuit 151 is connected to the corresponding emission control line EMi, and H level voltage of the emission control signal EM(i) is provided as the on-bias voltage Vobs.

Thus, the signal line or the voltage line connected to the first terminal of the bias application circuit 151 differs depending on the first to fourth configurations. However, the pixel circuits Pix(i, j) according to the first to fourth configuration examples in the present embodiment are all driven by the first scanning signal PS(i), the second scanning signals NS(i), NS(i−2), NS(i−X), the emission control signal EM(i), and the data signal D(j), which change as illustrated in FIG. 10, and all operate in the same manner as the pixel circuit Pix(i, j) in the third embodiment described above. Therefore, according to the present embodiment, even if any of the first to fourth configuration examples is adopted for the pixel circuit Pix(i, j), the same effects as those of the third embodiment is obtained.

In the pixel circuit 15 in the present embodiment, an N-type bias application transistor T8 is used (see FIG. 12). However, instead of this, a P-type bias application transistor T8 may be used, and the gate terminal of the bias application transistor T8 may be connected to the first scanning signal line PSi−X preceding the corresponding first scanning signal line PSi.

### 5. Fifth Embodiment

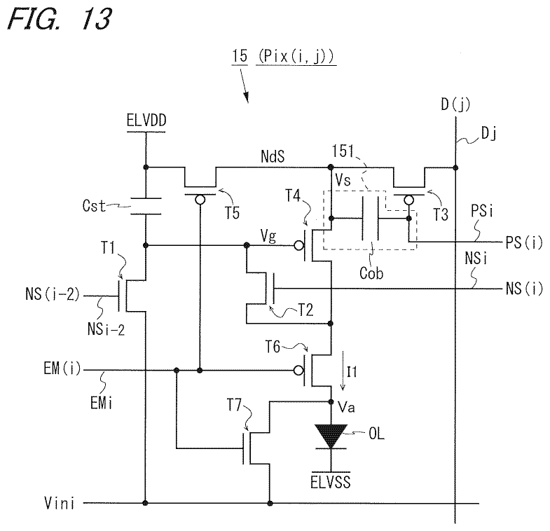

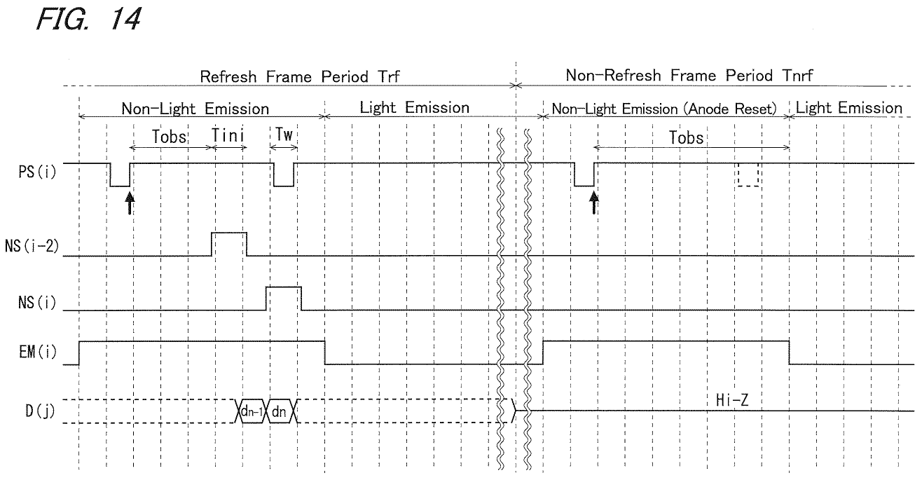

Next, an organic EL display device according to a fifth embodiment will be described with reference to FIGS. 13 and 14. Note that configurations of the present embodiment that are not newly described below are the same as those of the first embodiment (see FIGS. 1 and 4).

FIG. 13 is a circuit diagram illustrating a configuration of a pixel circuit Pix(i, j) in the i-th row and j-th column, which is a pixel circuit 15 in the present embodiment (1≤i≤n, 1≤j≤m). This pixel circuit 15 has the same configuration as the pixel circuit 15 (FIG. 4) in the first embodiment, except for the connection configuration of the bias application capacitor Cob that constitutes the bias application circuit 151.

In the bias application circuit 151 provided in the pixel circuit Pix(i, j) in the present embodiment, the first terminal is also connected to the second terminal via the bias application capacitor Cob. As illustrated in FIG. 13, the bias application circuit 151 has a first terminal connected to the corresponding first scanning signal line PSi, and a second terminal connected to the source terminal (node NdS) of the drive transistor T4. Therefore, the gate terminal of the write control transistor T3 to which the corresponding first scanning signal line PSi is connected is connected to the node NdS including the drain terminal of the write control transistor T3 via the bias application capacitor Cob. In consideration of such a connection configuration, the parasitic capacitance between the gate and drain of the write control transistor T3 in the pixel circuit Pix(i, j) may be used as the bias application capacitor Cob.

Next, the operation of the pixel circuit Pix(i, j) in the i-th row and j-th column in the present embodiment illustrated in FIG. 13 will be described with reference to FIG. 14. FIG. 14 is a timing chart for describing the operation of the pixel circuit Pix(i, j) in the non-light emission periods included in the RF frame period Trf and the NRF frame period Tnrf.

As illustrated in FIG. 14, the scanning-side drive circuit 40 in the present embodiment drives the first scanning signal lines PS1 to PSn during the RF frame period Trf, for each pixel circuit Pix(i, j) corresponding to each first scanning signal line PSi, such that the corresponding first scanning signal line PSi is not only in a selected state in the write period Tw, but also in a selected state for a predetermined period between the start of the non-light emission period and the start of the write period Tw. However, as can be seen by comparing FIG. 14 with FIG. 5, except for this point, during the RF frame period Trf, the first scanning signal PS(i), the second scanning signals NS(i), NS(i−2), the emission control signal EM(i), and the data signal D(j) for driving the pixel circuit Pix(i, j) in the present embodiment change in the same manner as the first scanning signal PS(i), the second scanning signals NS(i), NS(i−2), the emission control signal EM(i), and the data signal D(j) for driving the pixel circuit Pix(i, j) in the first embodiment described above. As a result, the transistors T1 to T3, T5 to T7 as switching elements included in the pixel circuit Pix(i, j) in the present embodiment operate in the same manner as the transistors T1 to T3, T5 to T7 as switching elements included in the pixel circuit Pix(i, j) in the first embodiment described above, thereby performing the same initialization operation and data writing operation.

As illustrated in FIG. 13, in the pixel circuit Pix(i, j) in the present embodiment, the bias application circuit 151 receives a corresponding first scanning signal PS(i) at the first terminal thereof. By driving the first scanning signal lines PS1 to PSn as described above, in the RF frame period Trf, the corresponding first scanning signal PS(i) is at L level for a predetermined period between a point when the non-light emission period is started by the change of the corresponding emission control signal EM(i) to H level and a point when the write period Tw is started by the change of the corresponding first scanning signal PS(i) to L level. However, from the viewpoint of lengthening the on-bias application period Tobs described below, it is preferable to place the predetermined period between the start of the non-light emission period and the start of the initialization period Tini, and it is even more preferable to place the predetermined period near the start H the non-light emission period. In the following, as illustrated in FIG. 14, it is assumed that the corresponding first scanning signal PS(i) is at L level for a predetermined period before the start of the initialization period Tini. In this way, at a point when the corresponding first scanning signal PS(i) changes from L level to H level after the start of the non-light emission period and before the start of the initialization period Tini (see the upward arrow in FIG. 14), the first emission control transistor T5 is in OFF state, and the write control transistor T3 changes from ON state to OFF state. Therefore, the voltage (source voltage) Vs of the source terminal of the drive transistor T4 changes in the same direction as the change of the corresponding first scanning signal PS(i) from L level to H level. That is, the source voltage Vs of the drive transistor T4 rises in response to the change of the corresponding first scanning signal PS(i) from L level to H level.

In the RF frame period Trf, the above-mentioned operation causes a relatively large voltage stress (Vgs) to be applied to the drive transistor T4 from when the corresponding first scanning signal PS(i) changes from L level to H level before the start of the initialization period Tini until when the initialization period Tini is started. Therefore, in the present embodiment, in the non-light emission period of the RF frame period Trf, the period from when the corresponding first scanning signal PS(i) changes from L level to H level before the start of the initialization period Tini until when the initialization period Tini is started is called the “on-bias application period Tobs.”

In the present embodiment, as illustrated in FIG. 14, the first scanning signal lines PS1 to PSn are driven such that the corresponding first scanning signal PS(i) is at L level during a predetermined period within the non-light emission period even in the NRF frame period Tnrf. Here, the first scanning signal lines PS1 to PSn may be driven such that the corresponding first scanning signal PS(i) becomes L level only once in the non-light emission period, or may be driven such that the corresponding first scanning signal PS(i) becomes L level twice, including the pulse shown by the dotted line in FIG. 14. Furthermore, the emission control lines EM1 to EMn are driven in the NRF frame period Tnrf in the same manner as in the RF frame period Trf. Each data signal line Dj is set to be in a high impedance state during the NRF frame period Tnrf.

Also in the NRF frame period Tnrf as in the RF frame period Trf, for each pixel circuit Pix(i, j), the above-described operation causes the corresponding first scanning signal PS(i) to be at L level during a predetermined period in the non-light emission period (see FIG. 14), and causes a relatively large voltage stress (Vgs) to be applied to the drive transistor T4 from when the corresponding first scanning signal PS(i) first changes from L level to H level in the non-light emission period until when the corresponding emission control signal EM(i) changes from H level to L level to start the light emission period.

According to the present embodiment as described above, similarly to the first embodiment, the difference in the stress state of the drive transistor T4 between the RF frame period Trf and the NRF frame period Tnrf is reduced regardless of the light emission duty, and the occurrence of flicker in the pause driving mode is sufficiently suppressed. Also in the present embodiment, as in the first embodiment described above, since there is no need for a separate voltage line or control line for applying the on-bias voltage to the drive transistor T4, it is possible to obtain such a flicker suppression effect in the pause driving mode without complicating the configuration and drive of the pixel circuit.

### 6. Modifications

The disclosure is not limited to the above-described embodiments, and various modifications can be made without departing from the scope of the disclosure. For example, the following modifications are possible.

In each of the above embodiments, the pixel circuit 15 includes both a P-type transistor and an N-type transistor, and typically, an LTPS-TFT with high mobility is used for the P-type transistor, and an oxide TFT such as an IGZO-TFT with good off-leakage characteristics is used for the N-type transistor. However, the disclosure is not limited to these TFTs, and the channel type of the transistor to be used may be appropriately changed between P type and N type to be configured to operate in the same manner. For example, in each embodiment, a configuration may be adopted in which an N-type LTPS-TFT is used in place of the P-type LTPS-TFT.

In the display devices according to the above embodiments, the pixel circuit 15 configured as illustrated in FIG. 4 etc. is used, but the configuration of the pixel circuit is not limited to this, and any pixel circuit may be used as long as it is an internal compensation type pixel circuit including a threshold compensation transistor, and is configured to hold the data voltage written to the holding capacitor while allowing the application of the on-bias voltage to reduce threshold shift caused by the hysteresis characteristics of the drive transistor.

In an organic EL display device having the pause driving mode such as the display devices according to the above embodiments, the emission control lines EM1 to EMn are typically driven to have the same light emission duty in both the RF frame period Trf and the NRF frame period Tnrf, but may be configured such that different emission duties can be set for the RF frame period Trf and the NRF frame period Tnrf.

As illustrated in FIG. 6, the first embodiment is configured such that the light emission duty is adjusted by changing the rising timing of the emission control signal EM(i), that is, the start timing of the non-light emission period. However, the light emission duty may be adjusted by changing the falling timing of the emission control signal EM(i), i.e., the end timing of the non-light emission period, without changing the rising timing of the emission control signal EM(i). This also applies to the other embodiments. However, in each of the above embodiments, since the on-bias application period Tobs is provided between the start of the non-light emission period and the start of the write period Tw in the non-light emission period within the RF frame period, the former configuration is more advantageous than the latter configuration in terms of sufficiently suppressing the occurrence of flicker in the pause driving mode regardless of the light emission duty. Furthermore, in the non-light emission period within the RF frame period, in addition to the above-mentioned on-bias application period Tobs, an on-bias application period may also be provided between the end of the write period Tw and the end of the non-light emission period. In this way, regardless of whether the former or latter configuration is adopted for adjusting the light emission duty, it is possible to sufficiently suppress the occurrence of flicker in the pause driving mode regardless of the light emission duty.

Each embodiment has been described above using an organic EL display device as an example, however, the disclosure is not limited to organic EL display devices, and can be applied to any display device that employs an internal compensation method using a display element driven by a current and that performs pause driving. Display elements that can be used here include, for example, inorganic light emitting diodes and quantum dot light emitting diodes (QLEDs) in addition to organic EL elements, that is, organic light emitting diodes (OLEDs).
10 Display Device
11 Display Portion
15 Pixel Circuit
20 Display Control Circuit
30 Data-Side Drive Circuit (Data Signal Line Drive Circuit)
40 Scanning-Side Drive Circuit (Scanning Signal Line Drive Circuit/Emission Control Circuit)
151 Bias Application Circuit
Pix(j, i) Pixel Circuit (i=1 to n, j=1 to m)
PSi First Scanning Signal Line (i=1, 2, . . . , n)
NSi Second Scanning Signal line (i=−1, 0, 1, . . . , n)
EMi Emission Control Line (i=1 to n)
PSBi Bias Control Line (i=1 to n)
Dj Data Signal Line (j=1 to m)
ELVDD High Level Power Supply Line (First Power Supply Line), High Level Power Supply Voltage
ELVSS Low Level Power Supply Line (Second Power Supply Line), Low Level Power Supply Voltage
OL Organic EL Element (Display Element)
Cst Holding Capacitor
Cob Bias Application Capacitor
T1 First Initialization Transistor
T2 Threshold Compensation Transistor
T3 Write Control Transistor
T4 Drive Transistor
T5 First Emission Control Transistor
T6 Second Emission Control Transistor
T7 Second Initialization Transistor
T8 Bias Application Transistor
TD Drive Period
TP Pause Period
Trf Refresh Frame Period (RF Frame Period)
Tnrf Non-Refresh Frame Period (NRF Frame Period)
Tobs On-Bias Application Period
Vobs On-Bias Voltage.

1. A display device comprising:
a display portion including a plurality of pixel circuits;
a drive circuit configured to drive the plurality of pixel circuits; and
a display control circuit configured to control the drive circuit such that a drive period and a pause period alternately appear, the drive period consisting of one or more refresh frame periods in which voltage of a plurality of data signals is written, as data voltage, to the plurality of pixel circuits, the pause period consisting of one or more non-refresh frame periods in which writing of data voltage to the plurality of pixel circuits is stopped,
wherein each of the plurality of pixel circuits includes
a display element configured to be driven by a current,
a drive transistor arranged in series with the display element and including a control terminal, a first conduction terminal, and a second conduction terminal,
a holding capacitor having one terminal connected to the control terminal of the drive transistor and thus being configured to hold a voltage of the control terminal of the drive transistor,
a write control transistor, as a switching element, having a first conduction terminal configured to receive a data voltage to be written to the holding capacitor and a second conduction terminal connected to the first conduction terminal of the drive transistor,
a threshold compensation transistor, as a switching element, arranged between the second conduction terminal and the control terminal of the drive transistor, and configured to put the drive transistor in a diode-connected state when in ON state,
at least one emission control transistor, as a switching element, arranged in series with the display element and the drive transistor, and
a bias application circuit configured to apply, to the first conduction terminal of the drive transistor, a bias voltage for reducing threshold voltage shift caused by a hysteresis characteristic of the drive transistor,
wherein in each of the plurality of pixel circuits, the bias application circuit has
a first terminal configured to receive one of signals provided to control terminals of transistors each of which is included in the each of the plurality of pixel circuits or in another pixel circuit, but none of which are included in the bias application circuit, or to receive one of the power supply voltages of the plurality of pixel circuits, and
a second terminal connected to the first conductive terminal of the drive transistor, and
the bias application circuit is configured to apply the bias voltage to the first conductive terminal of the drive transistor based on the signal or the voltage received at the first terminal.

2. The display device according to claim 1,
wherein the display control circuit
controls the drive circuit such that the emission control transistor turns on and off to cause the display element to emit light with a predetermined light emission duty during the refresh frame period and to emit light with a predetermined light emission duty during the non-refresh frame period, and such that the bias voltage is applied to the first conduction terminal of the drive transistor within a period during which the emission control transistor is in OFF state in each of the plurality of pixel circuits in both the refresh frame period and the non-refresh frame period; and
controls the drive circuit in the refresh frame period such that in each of the plurality of pixel circuits, the write control transistor and the threshold compensation transistor are each in ON state for a predetermined period within a period during which the emission control transistor is in OFF state, and such that in each of the plurality of pixel circuits, the bias application circuit applies the bias voltage to the first conduction terminal of the drive transistor based on the signal or voltage received at the first terminal during a bias period that is set to include at least a portion of a period from when the emission control transistor changes to OFF state until when the write control transistor changes to ON state.

3. The display device according to claim 2,
wherein the bias application circuit includes a bias application capacitor and has the first terminal connected to the second terminal via the bias application capacitor, and
each of the plurality of pixel circuits is configured such that, among signals provided to control terminals of transistors in pixel circuits other than the each of the plurality of pixel circuits, a signal capable of changing a voltage of the first conduction terminal of the drive transistor via the bias application capacitor in a direction to turn on the drive transistor within a period from when the emission control transistor changes to OFF state until when the write control transistor changes to ON state in the refresh frame period is provided to the first terminal of the bias application circuit.

4. The display device according to claim 3,
wherein the display portion further includes a plurality of data signal lines, a plurality of first scanning signal lines, a plurality of emission control lines, a first power supply line, and a second power supply line, and
the drive circuit includes:
a data-side drive circuit configured to generate and apply a plurality of data signals to the plurality of data signal lines; and
a scanning-side drive circuit configured to selectively drive the plurality of first scanning signal lines and selectively inactivate the plurality of emission control lines,
each of the plurality of pixel circuits corresponds to one of the plurality of data signal lines, corresponds to one of the plurality of first scanning signal lines, and corresponds to one of the plurality of emission control lines,
the at least one emission control transistor includes first and second emission control transistors each having control terminals connected to a corresponding emission control line,
the write control transistor further has a control terminal connected to a corresponding first scanning signal line,
the first conduction terminal of the drive transistor is connected to a corresponding data signal line via the write control transistor, and is connected to the first power supply line via the first emission control transistor, and is connected to a predetermined subsequent emission control line via the bias application capacitor,
the second conductive terminal of the drive transistor is connected to a first terminal of the display element
a second terminal of the display element is connected to the second power supply line, and
the predetermined subsequent emission control line is an emission control line that is selected for each of the plurality of pixel circuits from among emission control lines which become inactivated after the corresponding emission control line among the plurality of emission control lines, and that has a voltage changed in such a manner to change the voltage of the first conductive terminal of the drive transistor in a direction to turn on the drive transistor via the bias application capacitor within a period from when the corresponding emission control line changes to an inactivated state until when the corresponding first scanning signal line changes to the selected state in the refresh frame period.

5. The display device according to claim 2,
wherein the bias application circuit includes a bias application transistor, as a switching element, having first and second conductive terminals respectively connected to the first and second terminals of the bias application circuit,
the display control circuit is further configured to control the drive circuit such that the bias application transistor is in ON state during the bias period, and
each of the plurality of pixel circuits is configured such that either a signal having a voltage equivalent to the bias voltage during the bias period among signals provided to control terminals of transistors other than the bias application transistor in the each of the plurality of pixel circuit or in another pixel circuit, or a voltage equivalent to the bias voltage among the power supply voltages, is provided to the first terminal of the bias application circuit.

6. The display device according to claim 5,
wherein the display portion further includes a plurality of data signal lines, a plurality of first scanning signal lines, a plurality of emission control lines, a plurality of bias control lines, a first power supply line, and a second power supply line;
the drive circuit includes:
a data-side drive circuit configured to generate and apply a plurality of data signals to the plurality of data signal lines; and
a scanning-side drive circuit configured to selectively drive the plurality of first scanning signal lines and selectively inactivates the plurality of emission control lines;
each of the plurality of pixel circuits corresponds to one of the plurality of data signal lines, one of the plurality of first scanning signal lines, one of the plurality of emission control lines, and one of the plurality of bias control lines;
the at least one emission control transistor includes first and second emission control transistors each having control terminals connected to a corresponding emission control line;
the write control transistor further has a control terminal connected to a corresponding first scanning signal line;
the first conduction terminal of the drive transistor is connected to a corresponding data signal line via the write control transistor, and is connected to the first power supply line via the first emission control transistor;
the second conductive terminal of the drive transistor is connected to a first terminal of the display element via the second emission control transistor;
the first terminal of the bias application circuit is connected to the corresponding first scanning signal line;
the bias application transistor has a control terminal connected to a corresponding bias control line;
a second terminal of the display element is connected to the second power supply line; and
the scanning-side drive circuit is further configured to drive the plurality of bias control lines during the refresh frame period such that the bias application transistor in a pixel circuit corresponding to each of the plurality of bias control lines is in ON state during the bias period.

7. The display device according to claim 5,
wherein the display portion further includes a plurality of data signal lines, a plurality of first scanning signal lines, a plurality of emission control lines, a first power supply line, and a second power supply line,
the drive circuit includes:
a data-side drive circuit configured to generate and apply a plurality of data signals to the plurality of data signal lines; and
a scanning-side drive circuit configured to selectively drive the plurality of first scanning signal lines and selectively inactivate the plurality of emission control lines,
each of the plurality of pixel circuits corresponds to one of the plurality of data signal lines, one of the plurality of first scanning signal lines, and one of the plurality of emission control lines,
the at least one emission control transistor includes first and second emission control transistors each having control terminals connected to a corresponding emission control line,
the write control transistor further has a control terminal connected to a corresponding first scanning signal line,
the first conduction terminal of the drive transistor is connected to a corresponding data signal line via the write control transistor, and is connected to the first power supply line via the first emission control transistor,
the second conductive terminal of the drive transistor is connected to a first terminal of the display element via the second emission control transistor;
the first terminal of the bias application circuit is connected to the corresponding first scanning signal line;
the bias application transistor has a control terminal connected to a predetermined preceding first scanning signal line;
a second terminal of the display element is connected to the second power supply line; and
the predetermined preceding first scanning signal line is a first scanning signal line that is selected for each of the plurality of pixel circuits from among first scanning signal lines becoming a selected state before the corresponding first scanning signal line among the plurality of first scanning signal lines, and that is rendered in the selected state within a period from when the corresponding emission control line changes to an inactivated state until when the corresponding first scanning signal line changes to the selected state in the refresh frame period.

8. The display device according to claim 5,
wherein the display portion further includes a plurality of data signal lines, a plurality of first scanning signal lines, a plurality of second scanning signal lines, a plurality of emission control lines, a first power supply line, and a second power supply line;
the drive circuit includes:
a data-side drive circuit configured to generate and apply a plurality of data signals to the plurality of data signal lines; and
a scanning-side drive circuit configured to selectively drive the plurality of first scanning signal lines and selectively drive the plurality of second scanning signal lines and selectively inactivate the plurality of emission control lines;
each of the plurality of pixel circuits corresponds to one of the plurality of data signal lines, one of the plurality of first scanning signal lines, one of the plurality of second scanning signal lines, and one of the plurality of emission control lines;
the at least one emission control transistor includes first and second emission control transistors that are both of a P-channel type and each have control terminals connected to a corresponding emission control line;
the write control transistor is of a P-channel type and further has a control terminal connected to a corresponding first scanning signal line;
the threshold compensation transistor is of an N-channel type and further has a control terminal connected to a corresponding second scanning signal line;
the drive transistor is of a P-channel type, and has the first conduction terminal connected to a corresponding data signal line via the write control transistor and to the first power supply line via the first emission control transistor, and the second conduction terminal connected to a first terminal of the display element via the second emission control transistor, and
a second terminal of the display element connected to the second power supply line; and
the bias application transistor has a control terminal connected to a scanning signal line which is selected from first scanning signal lines rendered in a selected state before the corresponding first scanning signal line among the plurality of first scanning signal lines and second scanning signal lines rendered in the selected state before the corresponding second scanning signal line among the plurality of second scanning signal lines, the selected scanning signal line turning on the bias application transistor within a period from when the corresponding emission control line changes to an inactivated state until when the corresponding first scanning signal line changes to the selected state in the refresh frame period;
the first terminal of the bias application circuit is connected to either the first power supply line, the corresponding first scanning signal line, or the corresponding emission control line.

9. The display device according to claim 2,
wherein the bias application circuit includes a bias application transistor, as a switching element, having first and second conduction terminals respectively connected to the first and second terminals of the bias application circuit,
the bias application transistor is configured in a diode connection configuration, and
each of the plurality of pixel circuits is configured such that a signal having a voltage equivalent to the bias voltage during the bias period is applied to the first terminal of the bias application circuit from among signals applied to control terminals of transistors other than the bias application transistor in the each of the plurality of pixel circuits or in another pixel circuit.

10. The display device according to claim 9,
wherein the display portion further includes a plurality of data signal lines, a plurality of first scanning signal lines, a plurality of second scanning signal lines, a plurality of emission control lines, a first power supply line, and a second power supply line;
the drive circuit includes:
a data-side drive circuit configured to generate and apply a plurality of data signals to the plurality of data signal lines; and
a scanning-side drive circuit configured to selectively drive the plurality of first scanning signal lines and selectively drive the plurality of second scanning signal lines and selectively inactivate the plurality of emission control lines;
each of the plurality of pixel circuits corresponds to one of the plurality of data signal lines, one of the plurality of first scanning signal lines, one of the plurality of second scanning signal lines, and one of the plurality of emission control lines;
the at least one emission control transistor includes first and second emission control transistors each having control terminals connected to a corresponding emission control line; and
the write control transistor further has a control terminal connected to a corresponding first scanning signal line;
the threshold compensation transistor further has a control terminal connected to a corresponding second scanning signal line
the first conduction terminal of the drive transistor is connected to a corresponding data signal line via the write control transistor and to the first power supply line via the first emission control transistor;
the second conduction terminal of the drive transistor is connected to a first terminal of the display element via the second emission control transistor;
the first terminal of the bias application circuit is connected to a predetermined preceding second scanning signal line;
a second terminal of the display element is connected to the second power supply line, and
the predetermined preceding second scanning signal line is a second scanning signal line that is selected for each of the plurality of pixel circuits from among second scanning signal lines becoming a selected state before the corresponding second scanning signal line among the plurality of second scanning signal lines, and that is rendered in the selected state within a period from when the corresponding emission control line changes to an inactivated state until when the corresponding first scanning signal line changes to the selected state in the refresh frame period.

11. The display device according to claim 9, wherein the bias application transistor is a P-channel transistor configured in a diode connection configuration by connecting the second conduction terminal to a control terminal, or an N-channel transistor configured in a diode connection configuration by connecting the first conduction terminal to a control terminal.

12. The display device according to claim 2,
wherein the bias application circuit includes a bias application capacitor and has the first terminal connected to the second terminal via the bias application capacitor;
each of the plurality of pixel circuits is configured such that a first scanning signal provided to a control terminal of the write control transistor in the each of the plurality of pixel circuits is provided to the first terminal of the bias application circuit; and
the drive circuit is configured to generate the first scanning signal such that, in the refresh frame period, the first scanning signal provided to the control terminal of the write control transistor in each of the plurality of pixel circuits is active during a write period of a data voltage to the holding capacitor in the each of the plurality of pixel circuits and is rendered active within a period from when the emission control transistor changes to OFF state until when the write period is started, and such that the first scanning signal changes to an inactive state before the write period so as to cause a voltage at the first conduction terminal of the drive transistor to change in a direction to turn on the drive transistor.

13. The display device according to claim 12,
wherein the display portion further includes a plurality of data signal lines, a plurality of first scanning signal lines, a plurality of emission control lines, a first power supply line, and a second power supply line,
the drive circuit includes:
a data-side drive circuit configured to generate and apply a plurality of data signals to the plurality of data signal lines; and
a scanning-side drive circuit configured to selectively drive the plurality of first scanning signal lines and selectively inactivate the plurality of emission control lines,
each of the plurality of pixel circuits corresponds to one of the plurality of data signal lines, corresponds to one of the plurality of first scanning signal lines, and corresponds to one of the plurality of emission control lines,
the at least one emission control transistor includes first and second emission control transistors each having control terminals connected to a corresponding emission control line,
the control terminal of the write control transistor is connected to a corresponding first scanning signal line,
the first conduction terminal of the drive transistor is connected to a corresponding data signal line via the write control transistor and is connected to the first power supply line via the first emission control transistor,
the second conductive terminal of the drive transistor is connected to a first terminal of the display element via the second emission control transistor,
a second terminal of the display element is connected to the second power supply line,
the first terminal of the bias application circuit in each of the plurality of pixel circuits is connected to the corresponding first scanning signal line, and
the scanning-side drive circuit drives the plurality of first scanning signal lines such that each of the plurality of first scanning signal lines is in a selected state during a write period of a data voltage to the holding capacitor in a pixel circuit corresponding to the each of the plurality of first scanning signal lines and is rendered in the selected state within a period from when the corresponding emission control line changes to an inactivated state until when the write period is started, and such that the each of the plurality of first scanning signals lines changes to a deselected state before the write period so as to cause a voltage of the first conductive terminal of the drive transistor to change in a direction to turn on the drive transistor.

14. A method for driving a display device using a display element driven by a current, wherein
the display device comprises a display portion including a plurality of pixel circuits,
each of the plurality of pixel circuits including:
a display element driven by a current;
a drive transistor having a control terminal, a first conduction terminal, and a second conduction terminal, and arranged in series with the display element;
a holding capacitor having one terminal connected to the control terminal of the drive transistor and thus being configured to hold a voltage at the control terminal of the drive transistor;
a write control transistor, as a switching element, having a first conduction terminal configured to receive a data voltage to be written to the holding capacitor and a second conduction terminal connected to the first conduction terminal of the drive transistor;
a threshold compensation transistor, as a switching element, arranged between the second conduction terminal and the control terminal of the drive transistor, and configured to put the drive transistor in a diode-connected state when in ON state;
at least one emission control transistor, as a switching element, arranged in series with the display element and the drive transistor, and
a bias application circuit configured to apply, to the first conductive terminal of the drive transistor, a bias voltage for reducing threshold voltage shift caused by a hysteresis characteristic of the drive transistor, wherein in each of the plurality of pixel circuits, the bias application circuit having a first terminal configured to receive one of signals provided to control terminals of transistors each of which is included in the each of the plurality of pixel circuits or in another pixel circuit, but none of which are included in the bias application circuit, or to receive one of the power supply voltages of the plurality of pixel circuits, and having a second terminal connected to the first conductive terminal of the drive transistor,
the method comprising performing a pause driving by driving the plurality of pixel circuits such that a drive period and a pause period alternately appear, the drive period consisting of one or more refresh frame periods in which voltage of a plurality of data signals is written, as data voltage, to the plurality of pixel circuits, the pause period consisting of one or more non-refresh frame periods in which writing of data voltage to the plurality of pixel circuits is stopped,
wherein the performing the pause driving includes performing a bias application by driving the plurality of pixel circuits such that the bias application circuit applies the bias voltage to the first conduction terminal of the drive transistor based on the signal or the voltage received at the first terminal within a period during which the emission control transistor in each of the plurality of pixel circuits is in OFF state in both the refresh frame period and the non-refresh frame period.

15. : The method according to claim 14, wherein the performing the pause driving further includes:
performing an emission control by turning on and off the emission control transistor such that the display element emits light with a predetermined light emission duty during the refresh frame period and the display element emits light with a predetermined light emission duty during the non-refresh frame period; and
performing a data writing by driving the plurality of pixel circuits such that the write control transistor and the threshold compensation transistor are each in ON state for a predetermined period within the period during which the emission control transistor is in OFF state in the refresh frame period; wherein
in the performing the bias application, the plurality of pixel circuits is driven such that the bias application circuit applies the bias voltage to the first conduction terminal of the drive transistor based on the signal or the voltage received at the first terminal during a bias period that is set to include at least a portion of the period from when the emission control transistor changes to OFF state until when the write control transistor changes to ON state in each of the plurality of pixel circuits in the refresh frame period.
